(19) United States
(12) Patent Application Publication
(10) Pub. No.: US 2025/0168760 A1
(43) Pub. Date: May 22, 2025

(54) USER EQUIPMENT INVOLVED DISTRIBUTED NON-ACCESS STRATUM

(71) Applicant: Apple Inc., Cupertino, CA (US)

(72) Inventors: Fangli Xu, Beijing (CN); Zhibin Wu, Los Altos, CA (US); Shu Guo, Beijing (CN); Yuqin Chen, Beijing (CN); Ralf Rossbach, Munich (DE); Behrouz Aghili, San Diego, CA (US); Haijing Hu, Los Gatos, CA (US); Peng Cheng, Beijing (CN); Naveen Kumar R. Palle Venkata, San Diego, CA (US); Sudeep Manithara Vamanan, Nuremberg (DE)

(73) Assignee: Apple Inc., Cupertino, CA (US)

(21) Appl. No.: 18/923,560

(22) Filed: Oct. 22, 2024

Related U.S. Application Data
(60) Provisional application No. 63/602,283, filed on Nov. 22, 2023.

(51) Int. Cl. H04W 48/18; H04L 41/12; H04W 48/16; H04W 76/27

(52) U.S. Cl. CPC H04W 48/18; H04L 41/12; H04W 48/16; H04W 76/27

(57) ABSTRACT

The present application relates to devices and components including apparatus, systems, and methods to establish and utilize NAS-X connections between a device and a network function of a network.

### CROSS-REFERENCE TO RELATED APPLICATION

This application claims priority to U.S. Provisional Patent Application No. 63/602,283, entitled “User Equipment Involved Distributed Non-Access Stratum,” filed on Nov. 22, 2023, the disclosure of which is incorporated by reference herein in its entirety for all purposes.

### TECHNICAL FIELD

The present application relates to the field of wireless technologies and, in particular, to user equipment involved distributed non-access stratum arrangements and operations.

### BACKGROUND

Third Generation Partnership Project (3GPP) networks provide for transmission of non-access stratum (NAS) messages between user equipments (UEs) and the networks. The NAS messages can be exchanged between the UEs and access and mobility management functions (AMFs) of the networks. In the instance where operation of another network function (NF) is to be utilized for a NAS message, the AMF forward the NAS message to the appropriate NF for processing.

### BRIEF DESCRIPTION OF THE DRAWINGS

FIG. 1 illustrates an example network arrangement in accordance with some embodiments.

FIG. 2 illustrates an example network arrangement in accordance with some embodiments.

FIG. 3 illustrates an example RRCreconfiguration information element that can be included in non-access stratum (NAS) signaling messages in accordance with some embodiments.

FIG. 4 illustrates example information elements that can be included in NAS signaling messages in accordance with some embodiments.

FIG. 5 illustrates an example DLInformationTransfer message that can be transmitted as an NAS signaling message in accordance with some embodiments.

FIG. 6 illustrates an example ULInformationTransfer message that can be transmitted as an NAS signaling message in accordance with some embodiments.

FIG. 7 illustrates an example NAS transport arrangement in accordance with some embodiments.

FIG. 8 illustrates an example system arrangement in accordance with some embodiments.

FIG. 9 illustrates an example international mobile telecommunications (IMT)-2030 capabilities representation in accordance with some embodiments.

FIG. 10 illustrates an example legacy control plane (CP) protocol stack representation 1000 in accordance with some embodiments.

FIG. 11 illustrates a first portion of an example stack representation in accordance with some embodiments.

FIG. 12 illustrates a second portion of the example stack representation of FIG. 11 in accordance with some embodiments.

FIG. 13 illustrates example message arrangements for option 1 in accordance with some embodiments.

FIG. 14 illustrates an example message arrangement for option 2 in accordance with some embodiments.

FIG. 15 illustrates example message arrangements for option 3 in accordance with some embodiments.

FIG. 16 illustrates example message arrangements for option 4 in accordance with some embodiments.

FIG. 17 illustrates example message arrangements for option 5 in accordance with some embodiments.

FIG. 18 illustrates example message arrangements for option 6 in accordance with some embodiments.

FIG. 19 illustrates an example service request arrangement for option 1.1 in accordance with some embodiments.

FIG. 20 illustrates an example service request arrangement for option 1.2 in accordance with some embodiments.

FIG. 21 illustrates an example service request arrangement for option 2 in accordance with some embodiments.

FIG. 22 illustrates example network function (NF) arrangement in accordance with some embodiments.

FIG. 23 illustrates an example user equipment (UE) mobility arrangement in accordance with some embodiments.

FIG. 24 illustrates an example UE handover (HO) arrangement in accordance with some embodiments.

FIG. 25 illustrates an example UE HO arrangement in accordance with some embodiments.

FIG. 26 illustrates an example procedure for generating a NAS-X message in accordance with some embodiments.

FIG. 27 illustrates an example procedure for establishing an NAS-X connection in accordance with some embodiments.

FIG. 28 illustrates an example procedure for providing an NAS message to an NF in accordance with some embodiments.

FIG. 29 illustrates an example UE in accordance with some embodiments.

FIG. 30 illustrates an example next generation NodeB (gNB) in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

The term “base station” as used herein may include a base station, any generation of NodeB (including a NodeB, an evolved NodeB (eNB), and a next generation NodeB (gNB)), and/or radio access network (RAN) node. Further, the terms “gNB” and “RAN node” can refer to a base station, any generation of NodeB, and/or a RAN node.

In legacy network arrangements, access and mobility management functions (AMFs) receive the non-access stratum (NAS) messages from the user equipments (UEs) via base stations connected to the AMFs. The legacy AMFs determine which network function (NF) each of the non-access stratum (NAS) messages is to be directed and forwards the NAS messages to the appropriate NF. As each AMF can be connected to multiple base stations and/or UEs, the AMF would process the NAS messages from each of the base stations and/or UEs. As the number of NAS messages continue to grow with network advancements, the AMF may become a point of delay as it could have issues with processing all the NAS messages in a timely manner.

Approaches described throughout this disclosure allow NAS messages to be transmitted via NAS-X connections directly to the target NFs rather than having to pass through AMFs to arrive at the target NFs. A base station of the network can receive NAS messages from connected UEs and direct the NAS messages to the appropriate NAS-X connections for the target NFs. As the base station processes NAS messages for the single base station as compared to the legacy AMFs that processed NAS messages for multiple base stations, the approaches of using the base stations to direct the NAS messages via the NAS-X connections to the target NFs can result in faster processing of NAS messages and/or can alleviate the point of delay of the legacy AMFs.

### NAS Connection Between Core Network (CN) and UE

### Fifth Generation (5G): Radio Resource Control (RRC) Aspect for NAS Signaling Transmission

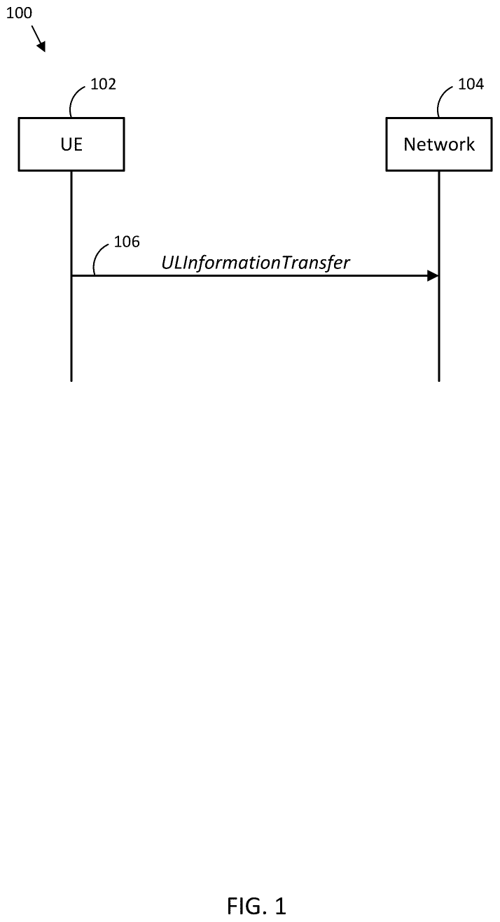

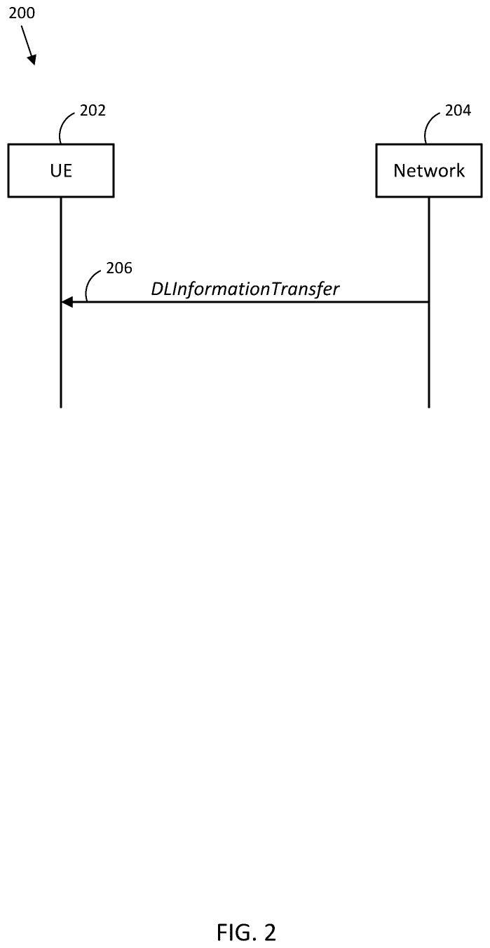

Legacy access stratum (AS) RRC message design can include the following features. UE dedicated NAS messages are delivered via signaling radio bearer 1 (SRB1) or signaling radio bearer 2 (SRB2). The UE dedicated NAS messages are transparent to RRC. The messages illustrated in FIG. 1 and FIG. 2 can be used to carry NAS signaling.

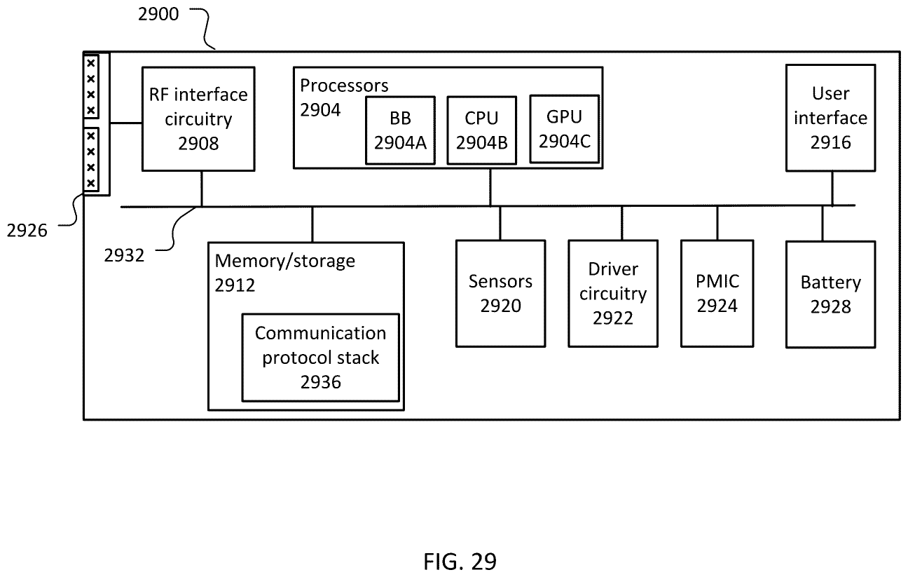

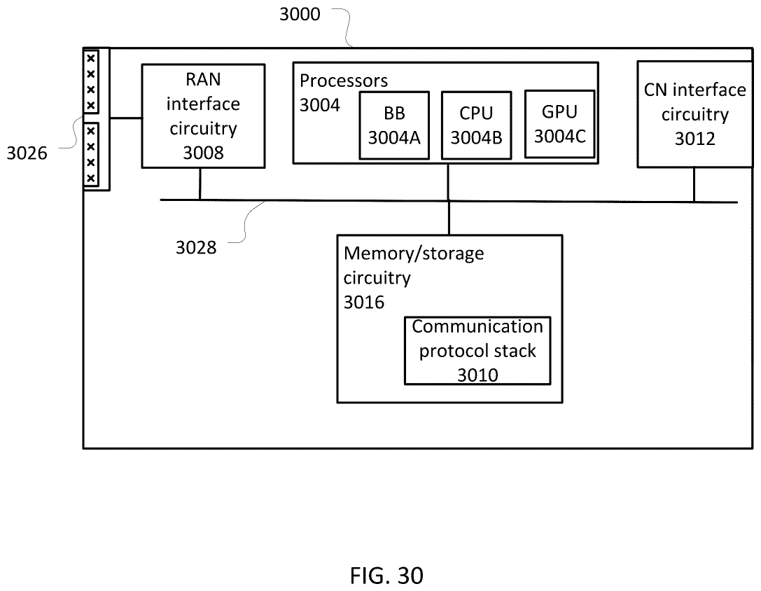

FIG. 1 illustrates an example network arrangement 100 in accordance with some embodiments. The network arrangement 100 includes a UE 102. The UE 102 may include one or more of the features of the UE 2900 (FIG. 29). The network arrangement 100 includes a network 104. The network 104 can include a base station (such as the gNB 3000 (FIG. 30)) and/or a core network. The UE 102 may transmit an uplink (UL) information transfer message 106 to the network 104. The UL information transfer message 106 may be used for carrying NAS signaling.

FIG. 2 illustrates an example network arrangement 200 in accordance with some embodiments. The network arrangement 200 includes a UE 202. The UE 202 may include one or more of the features of the UE 2900 (FIG. 29). The network arrangement 200 includes a network 204. The network 204 can include a base station (such as the gNB 3000 (FIG. 30)) and/or a core network. The UE 202 may transmit a downlink (DL) information transfer message 206 to the network 204. The DL information transfer message 206 may be used for carrying NAS signaling.

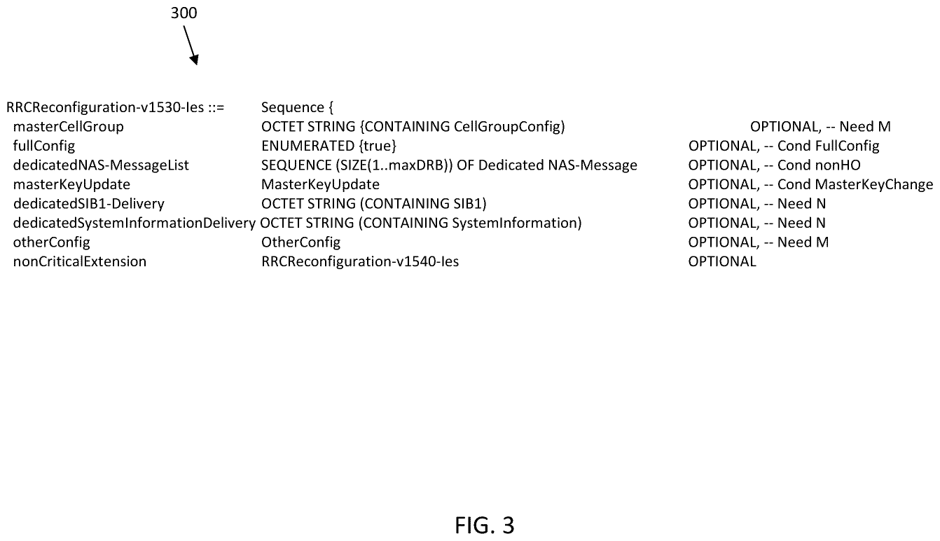

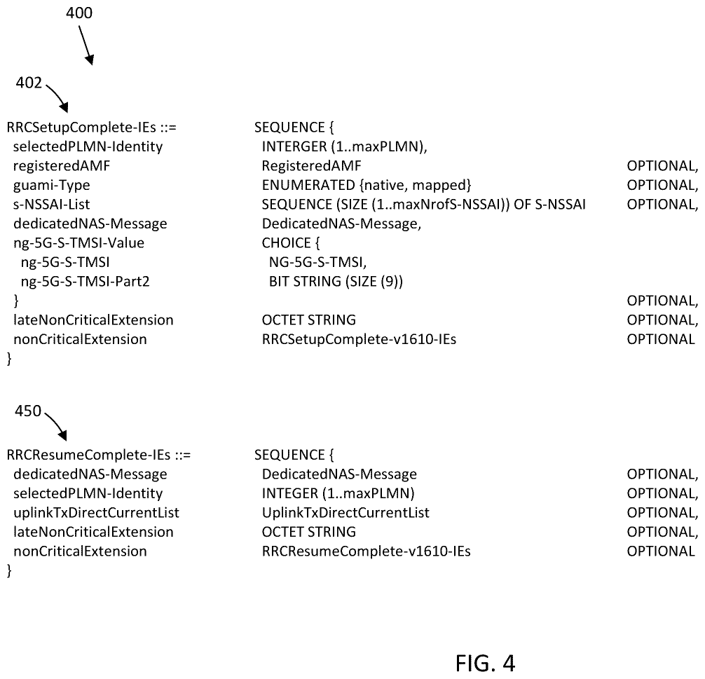

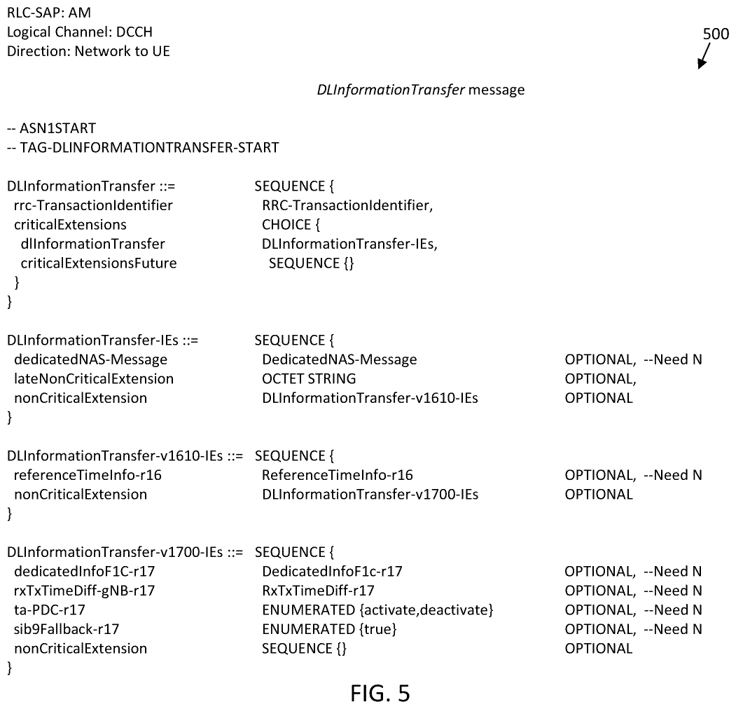

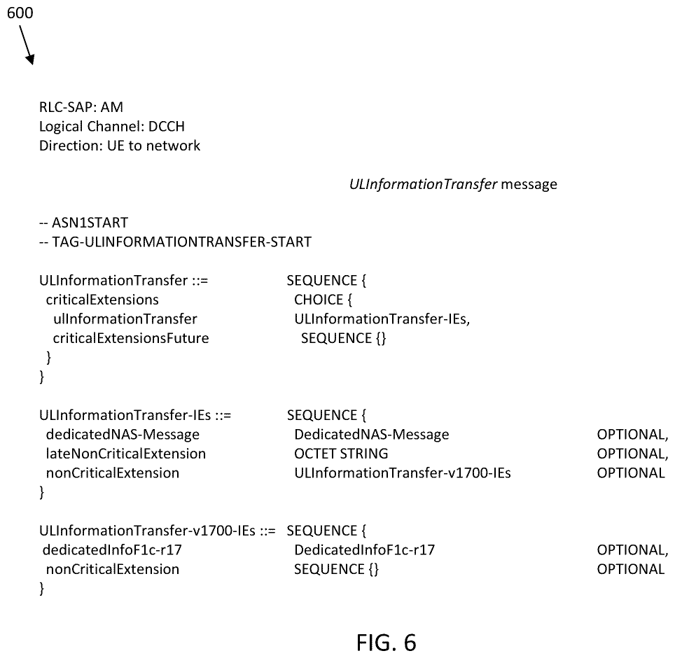

FIGS. 3-6 illustrate example information elements that can be included in NAS signaling messages. FIG. 3 illustrates an example RRCreconfiguration information element 300 that can be included in NAS signaling messages in accordance with some embodiments. FIG. 4 illustrates example information elements 400 that can be included in NAS signaling messages in accordance with some embodiments. The information elements 400 include an RRCSetupComplete information element 402 and an RRCResumeComplete information element 450. FIG. 5 illustrates an example DLInformationTransfer message 500 that can be transmitted as an NAS signaling message in accordance with some embodiments. FIG. 6 illustrates an example ULInformationTransfer message 600 that can be transmitted as an NAS signaling message in accordance with some embodiments.

During initial access (Resume/Setup), the NAS message may be carried in RRCResumeComplete and RRCSetupComplete message. For example, the NAS message may be included in the RRCResumeComplete information element 450 (FIG. 4) and/or the RRCSetupComplete information element 402 (FIG. 4) during an initial access of a UE to a network.

In CONNECTED mode, NAS messages may be transmitted in a UL direction and in a DL direction. In the UL direction, the NAS messages may be carried in ULInformationTransfer. For example, the NAS messages may be carried in the ULInformationTransfer message 600 (FIG. 6) in the UL direction. In the DL direction, the NAS messages may be carried in DLInformationTransfer, or in RRCReconfiguration (no handover (HO) case). For example, the NAS messages may be carried in the DLInformation Transfer message 500 (FIG. 5) in the DL direction, or in the RRCreconfiguration information element 300 (FIG. 3) in instances where there is no HO.

For UE operation, one or more of the following features may be implemented by the UE for NAS signaling. In IDLE/INACTIVE mode, there may be no NAS signaling. For example, a UE may not perform NAS signaling when the UE is in IDLE and/or INACTIVE mode. In CONNECTED mode, in DL direction the received signaling may be forwarded to NAS. In UL direction, the NAS signaling may be carried in RRC message for transmission.

For next generation NodeB (gNB) (where the gNB may be a base station) operation (In gNB-central unit (CU)), the NAS message may be forwarded between UE and AMF. AMF selection may be based on fifth generation shortened form of temporary mobile subscriber identity (5G-S-TMSI) or globally unique access and mobility management function identifier (GUAMI) (TS 23.501, section 6.3.5 of technical specification (TS 23.501 (3^{rd} Generation Partnership Project; Technical Specification Group Services and System Aspects; System architecture for the 5G System (5GS); Stage 2 (Release 18). (2023). 3GPP TS 23.501, 18.3.0).

### 5G: Control Plane (CP) Protocol Stack for NAS Transport

Characteristics of the CP protocol stack for NAS transport may include that all NAS signaling is anchored/terminated at AMF. Other core network (CN) entities communicate with UE indirectly via AMF.

Details of the CP protocol stack for NAS transport may include one or more of the following. NAS signaling may be transmitted transparently via radio access network (RAN) between UEs and AMFs. NAS proposal may consist of non-access stratum mobility management (NAS-MM) messages for registration management (RM)/connection management (CM), security, etc., and may also provide the transport service for other payloads, e.g., session management (SM), UE policy, etc. In CN side, AMF may be the anchor and may terminate NAS-MM messages, and forward the payloads transparently to the relevant network functions (NFs), e.g. SM to session management function (SMF), UE policy to policy control function (PCF), etc. Other NFs (e.g. SMF, PCF) terminate NAS-MM payloads and communicate indirectly with UE via AMF. Note that NAS-X connection may provide direct/indirect communication between UE and NFs.

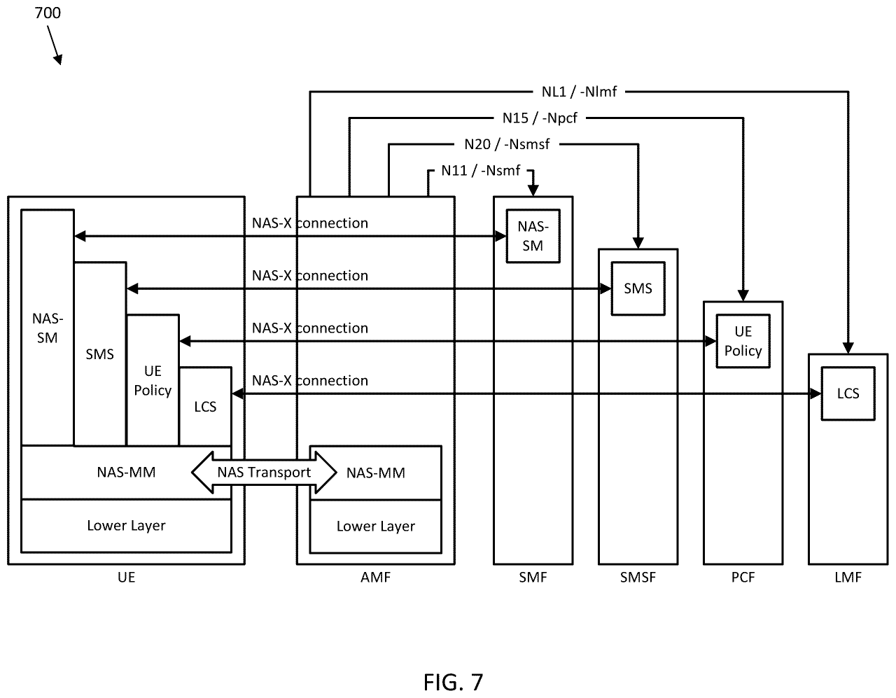

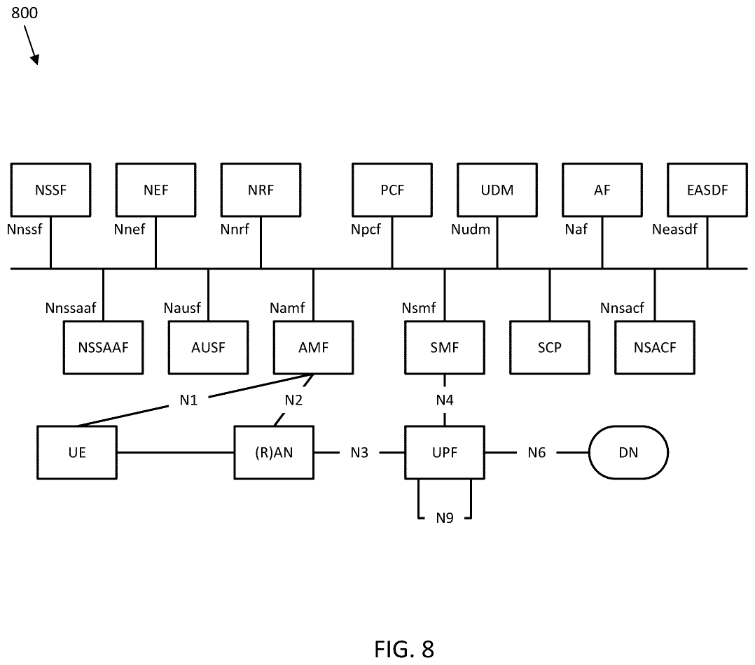

FIG. 7 illustrates an example NAS transport arrangement 700 in accordance with some embodiments. The NAS transport arrangement 700 illustrates NAS transport for SM, short message service (SMS), UE policy, and/or location services (LCS). FIG. 8 illustrates an example system arrangement 800 in accordance with some embodiments.

### Sixth Generation (6G): Capability of International Mobile Telecommunications (IMT)-2030

IMT-2030 is expected to provide enhanced capabilities compared to IMT-2020, as well as new capabilities to support the expanded usage scenarios of IMT-2030. Capabilities of IMT-2030 may include one or more of the following. The capabilities may include peak data rate (values of 50, 100, 200 gigabits per second (Gbit/s) are given as possible examples applicable for specific scenarios), user experienced data rate (values of 300 megabits per second (Mbit/s) and 500 Mbit/s), spectrum efficiency (values of 1.5 and 3 times greater than that of IMT-2020), area traffic efficiency (values of 30 megabits per second per meter squared (Mbit/s/m²) and 50 Mbit/s/m²), connection density (106-108 devices/kilometer (km)), mobility (500-1000 km/hour (h)), latency (0.1-1 milliseconds (ms)), reliability (1-10⁻⁵ to 1-10⁻⁷), coverage (coverage is defined as the cell edge distance of a single cell through link budget analysis), positioning (accuracy could be 1-10 centimeters (cm)), sensing-related capability (may be measured in terms of accuracy, resolution, detection rate, false alarm rate, etc.), artificial intelligence (AI)-related capability (incl. distributed data processing, distributed learning, AI computing, AI model execution, and AI model inference, etc.), security, privacy and resilience, sustainability (energy efficiency is a quantifiable metric of sustainability), and/or interoperability (refer to the radio interface being based on member-inclusivity and transparency, and functionality(ies) between different entities of the system).

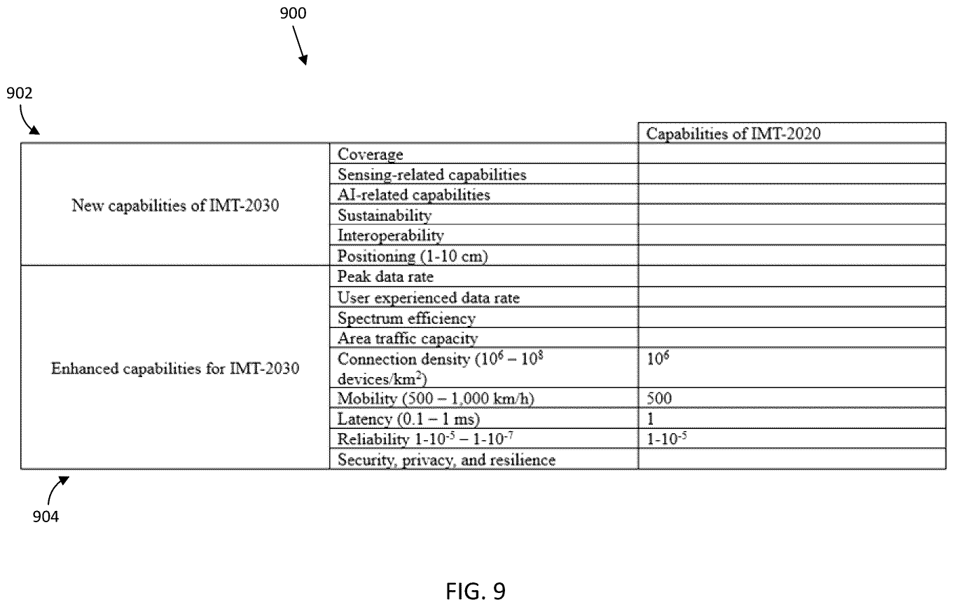

FIG. 9 illustrates an example IMT-2030 capabilities representation 900 in accordance with some embodiments. The IMT-2030 capabilities representation 900 illustrates example capabilities that are expected to be implemented in IMT-2030. The IMT-2030 capabilities representation 900 illustrates new capabilities 902 expected to be included in IMT-2030 and enhanced capabilities 904 expected to be included in IMT-2030. The range of values given for the capabilities within the IMT-2030 capabilities representation 900 are estimated targets for research and investigation of IMT-2030.

### 6G Challenges to 5G NAS Signaling Transport Design

Trends of 6G and challenges to 5G may include one or more of the following. As a first challenge, 6G capability on connection density (106-108 devices/km) may be greater than that in 5G. As an observation, due to the increase in connection density, the amount of NAS signaling may increase, and may be far greater than that in 5G. A challenge presented is that a significant increase in NAS signaling transmission between UE and CN may increase the burden on AMF.

As a second challenge, 6G capability on latency (0.1-1 ms) may be shorter than that in 5G. As an observation, low latency means the transmission between UE and CN may be faster than in 5G. A challenge is that the NAS signaling transport indirectly between UEs and other NFs via AMF will increase the latency of NAS signaling transmission and procedure.

As a third challenge, 6G new capabilities (e.g. AI, Sensing) may introduce new NFs to handle the new use scenarios in core network side. As an observation, new NAS procedure/signaling transport between UE and NAS may be introduced to handle the new use scenarios. A challenge is still keeping AMF as the anchor to forwarding NAS signaling between UE and new NFs is not good to support the new use scenario with good performance from signaling latency and AMF load aspects.

### Issue Statement

Issues on 5G NAS signaling transport design may include the following. In 5G, AMF is the anchor to handle all the NAS messages to and from UE, i.e., terminate NAS-MM messages, and forward the payloads transparently to the relevant NFs. To support the 6G visions/trends, 5G design has some issues. As a first issue, the AMF will be overloaded due to the significant NAS signaling increase. As a second issue, the AMF will be much complex due to more and more new NFs introduced in 6G, which can contribute to signaling latency and AMF load aspects.

Some 6G design considerations on NAS signaling transport mechanism may include the following. A direction may be to support direct NAS signaling communication between UE and CN functions via RAN node, i.e. no need to forwarded via AMF. On this direction, the one or more of the following issues are addressed in the approaches described throughout this disclosure. 1. How can RAN node identify and forward the NAS messages to the different NFs? 2. How to establish the direct NAS-X connection between UE and NFs? 3. Any relationship between the different NAS-X connections at the same time? 4. How to handle the mobility for the UE with multiple NAS-X connections?

### Approach

### General Description

For one UE connection, multiple NAS-X connections can be established between UE and different NFs for different purposes. For example, a UE may establish one or more NAS-X connections with NFs within a network. The NAS-X connections may be between the UE and the NFs. The NAS-X connections may be direct connections between the UE and the NFs such that messages transmitted via the NAS-X connections can be exchanged between the UE and the NFs without having an AMF of the network as an intermediary. Accordingly, the AMF will not have to receive and forward the messages transmitted to different NFs via the NAS-X connections.

There may be two options of the multiple NAS-X connections between UE and NFs. In a first option (which may be referred to as Option 1), NAS-X connections may be established between a UE and different NF types. In a second option (which may be referred to as Option 2), NAS-X connections may be established between a UE and different NFs belonging to the same NF type. (e.g., a network may include more than 1 session management functions (SMFs) for NAS-SM function due to slicing concept).

For each NAS-X connection, a RAN node can distinguish the NAS-X connection and forward the NAS message to the corresponding NFs. In order to distinguish NAS-X connection in a RAN node, an AS procedure for the NAS message transportation may be redesigned. NAS messages about NAS-X connection are transmitted and can be distinguished via RRC directly between UE and gNB.

There may be associations between different NAS-X connections of one UE. A NAS-AMF connection (i.e., connection between UE and anchor AMF) may be an anchor connection for the UE. The other NAS-X connections are associated to one NAS-AMF connection.

NF selection may be made amongst multiple NFs of the same NAS-X connection type. NF selection can be performed in UE, or gNB, or AMF, or based on some rules. Mobility may be based on anchor NAS-AMF connection. If the anchor AMF changes, the associated NAS-X connections (if it is impacted) may change at the same time. The AMF may have awareness of other NAS-X connections.

### Control Plane Protocol Stack for NAS Signaling Transportation

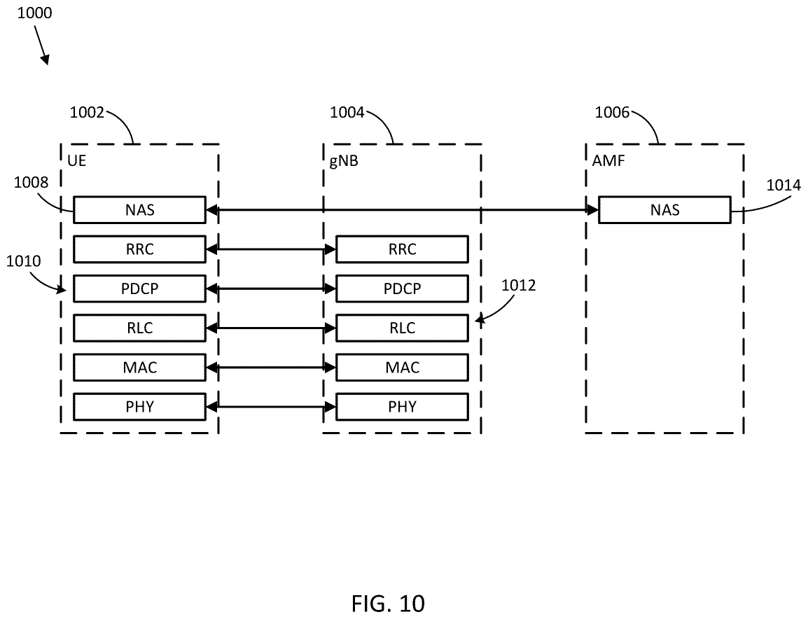

FIG. 10 illustrates an example legacy CP protocol stack representation 1000 in accordance with some embodiments. The CP protocol stack representation 1000 illustrates transmissions of NAS messages in accordance with legacy systems.

The CP protocol stack representation 1000 may include a UE 1002, a base station 1004 (which may be a gNB), and an AMF 1006. The UE 1002 may include one or more features of the UE 2900 (FIG. 29). The base station 1004 may include one or more of the features of the gNB 3000 (FIG. 30). The AMF 1006 may be an AMF of a core network. The UE 1002 may establish a connection with the AMF 1006 via the base station 1004.

The UE 1002 may include an NAS layer 1008. The UE 1002 may further include one or more other protocol layers 1010, which include an RRC layer, a packet data convergence protocol (PDCP) layer, a radio link control (RLC) layer, a medium access control (MAC) layer, and a physical layer (PHY) in the illustrated embodiment.

The base station 1004 may include one or more protocol layers 1012 corresponding to the one or more other protocol layers 1010 of the UE. The messages within the one or more other protocol layers 1010 and the one or more protocol layers 1012 may be exchanged between the UE 1002 and the base station 1004, such that the messages can be processed by the UE 1002 and the base station 1004.

The AMF 1006 may include a NAS layer 1014. The messages within the NAS layer 1008 and the NAS layer 1014 may be exchanged between the UE 1002 and the AMF 1006, such that the messages can be processed by the UE 1002 and the AMF 1006. The base station 1004 can forward the messages between the NAS layer 108 and the NAS layer 1014.

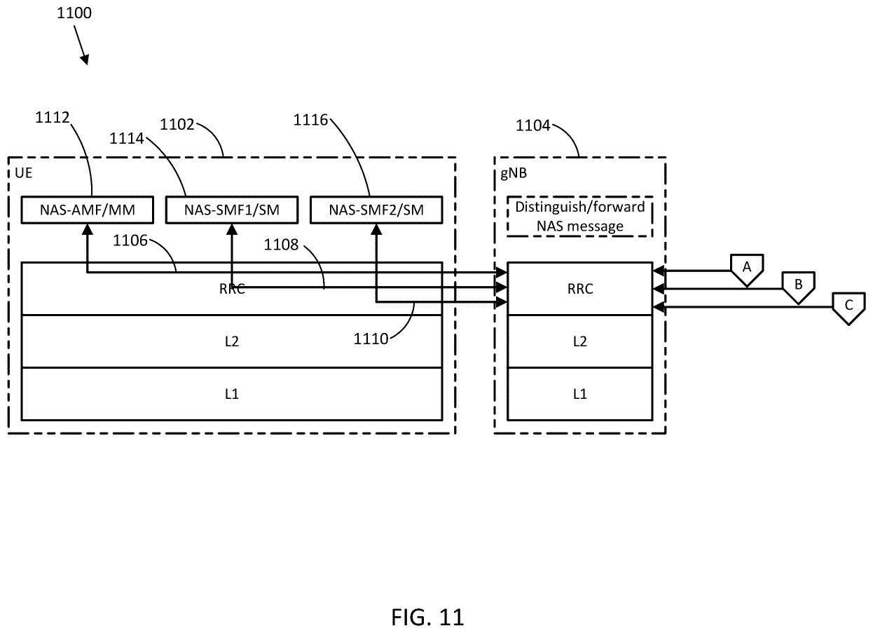

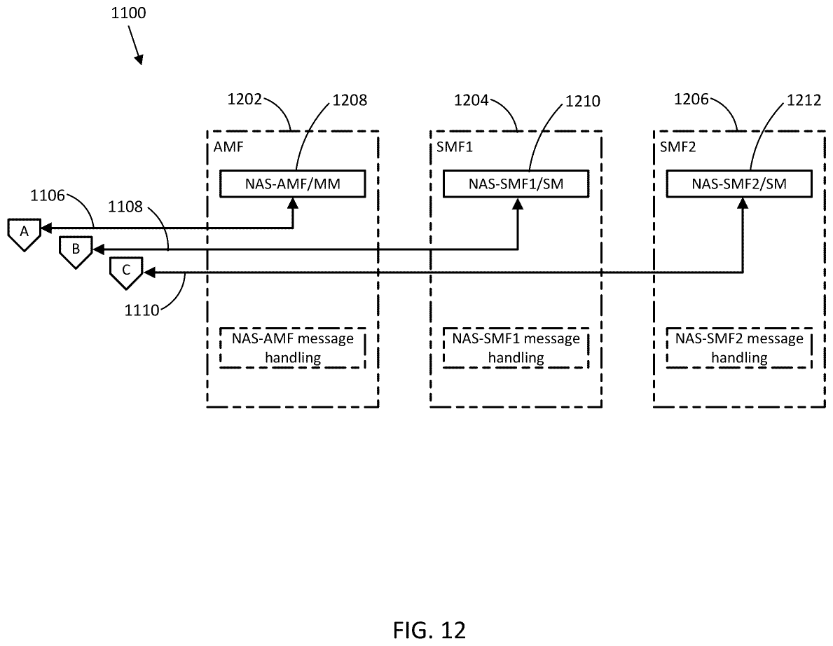

FIG. 11 and FIG. 12 illustrate an example stack representation 1100 for UE involved distributed NAS architecture in accordance with some embodiments. In particular, FIG. 11 illustrates a first portion of an example stack representation 1100 in accordance with some embodiments. FIG. 12 illustrates a second portion of the example stack representation 1100 in accordance with some embodiments.

The stack representation 1100 may include a UE 1102, a base station 1104, and one or more NFs of a network. In the illustrated embodiment, the one or more NFs include an AMF 1202, a first SMF 1204, and a second SMF 1206. The UE 1102 may include one or more of the features of the UE 2900 (FIG. 29). The base station 1104 may include one or more of the features of the gNB 3000 (FIG. 30).

The UE 1102 may establish NAS-X connections with the NFs of the network via the base station 1104, as described further throughout this disclosure. In the illustrated embodiment, the UE 1102 may establish a NAS-AMF connection 1106 with the AMF 1202, a first NAS-SMF connection 1108 with the first SMF 1204, and a second NAS-SMF connection 1110 with the second SMF 1206. Not that the NAS-AMF and NAS-SMF in the stack representation 1100 are examples.

The NAS-AMF connection 1106 may be utilized for exchanging non-access stratum-mobility management (NAS-MM) messages between the UE 1102 and the AMF 1202. The UE 1102 includes an NAS-AMF/MM representation 1112 and the AMF 1202 includes an NAS-AMF/MM representation 1208 in the illustrated embodiment to illustrate that the UE 1102 and the AMF 1202 can exchange NAS-MM messages. The AMF 1202 may handle NAS-AMF messages received from the UE 1102.

The first NAS-SMF connection 1108 may be utilized for exchanging non-access stratum-session management (NAS-SM) messages between the UE 1102 and the first SMF 1204. The UE 1102 includes an NAS-SMF1/SM representation 1114 and the first SMF 1204 includes an NAS-SMF1/SM representation 1210 in the illustrated embodiment to illustrate that the UE 1102 and the first SMF 1204 can exchange NAS-SM messages. The first SMF 1204 may handle NAS-SMF1 messages received from the UE 1102.

The second NAS-SMF connection 1110 may be utilized for exchanging NAS-SM messages between the UE 1102 and the second SMF 1206. The UE 1102 includes an NAS-SMF2/SM representation 1116 and the second SMF 1206 includes an NAS-SMF2/SM representation 1212 in the illustrated embodiment to illustrate that the UE 1102 and the second SMF 1206 can exchange NAS-SM messages. The second SMF 1206 may handle NAS-SMF2 messages received from the UE 1102.

The messages transmitted via the NAS-AMF connection 1106, the first NAS-SMF connection 1108, and the second NAS-SMF connection 1110 may be transmitted via the RRC layer. Accordingly, the messages may be RRC messages.

The UE 1102 may generate messages to be transmitted via the NAS-AMF connection 1106, the first NAS-SMF connection 1108, and the second NAS-SMF connection 1110. As part of generating the messages, the UE 1102 may include an indication of the target NAS-X connection and/or the target NF for the message, as described further throughout this disclosure. The UE 1102 may transmit the messages to the base station 1104.

The base station 1104 may receive the messages from the UE 1102. The base station 1104 may identify the indication of the target NAS-X connection and/or the target NF for the received messages. The base station 1104 may then forward the messages to the appropriate one of the AMF 1202, the first SMF 1204, or the second SMF 1206 based on the indication. Since the base station 1104 can forward the messages directly to the appropriate NF rather than all of the messages being forwarded to the AMF 1202 (as in legacy approaches), the demands on the AMF 1202 may be reduced as compared to the legacy approaches.

### NAS-X Connection Identification in RAN Node

Different NAS-X connections can be identified between a UE and a RAN node in the following options. For example, the UE may generate the messages in accordance with any of the following options to indicate target NAS-X connections and/or NFs for the messages. The UE may transmit the messages to base station. The base station may determine the target NAS-X connections and/or NFs based on the indications and forward the messages to the appropriate NFs based on the indications.

In option 1, explicit indication may be included in an RRC message to identify the NAS-X connection. For example, the UE may generate a NAS message to be transmitted via one of the NAS-X connections that the UE has established with NFs of the network. The NAS message may include an indication that indicates the target NAS-X connection and/or the target NF for the NAS-X message. The NAS message may be an RRC message. One SRB may be used for the transmission of all NAS messages, and the NAS-X connection identity may be explicitly indicated in the RRC message.

In option 2, an SRB level NAS-X connection identification may be implemented. Different SRBs may be used to transmit the NAS messages of different NAS-X connections. For example, each of the NAS-X connections established by a UE may have a corresponding SRB. Accordingly, the SRB on which a NAS message is transmitted by the UE may indicate a target NAS-X connection and/or a target NF for the NAS message. The UE may transmit the NAS message on an SRB, or indicate an SRB on which the NAS message is to be transmitted, to indicate the target NAS-X connection and/or the target NF.

In option 3, a radio link control (RLC) bearer and/or a logical channel (LCH) level NAS-X connection identification may be implemented. Different RLC bearers and/or LCHs may be used for the transmission of NAS-messages belonging to different NAS-X connections. For example, each of the NAS-X connections established by a UE may have a corresponding RLC bearer and/or LCH. Accordingly, the RLC bearer and/or the LCH with which a NAS message is associated may indicate a target NAS-X connection and/or a target NF for the NAS message. The UE may transmit the NAS message on an RLC bearer, indicate an RLC bearer on which the NAS message is to be transmitted, utilize an LCH, and/or indicate an LCH to be utilized to indicate the target NAS-X connection and/or the target NF.

Option 4 may be a combination of option 1 and option 2. Option 2 may be implemented by using an SRB to identify the NAS-X connection type, and option 1 may be implemented by using an explicit indication in RRC message to identify one special NAS-X connection of the same type. For example, the UE may generate a NAS message with an indication that indicates a target NAS-X connection and/or target NF of a NAS-X connection type, and the UE may transmit the NAS message on an SRB, or indicate an SRB on which the NAS message is to be transmitted, to indicate the NAS-X connection type.

Option 5 may be a combination of option 1 and option 3. Option 3 may be implemented by using an LCH to identify the NAS-X connection type, and option 1 may be implemented by using explicit indication in RRC message to identify one special NAS-X connection of the same type. For example, the UE may generate a NAS message with an indication that indicates a target NAS-X connection and/or target NF of a NAS-X connection type, and the UE may utilize an LCH for the NAS message, or indicate an LCH to be used for the NAS message, to indicate the NAS-X connection type.

Option 6 may be a combination of option 2 and option 3. Option 2 may be implemented by using an SRB to identify the NAS-X connection type, and option 3 may be implemented by using an LCH to identify the NAS-X connection of the same type. For example, the UE may utilize an LCH, or indicate an LCH to be utilized, for a NAS message that indicates a target NAS-X connection and/or target NF of a NAS-X connection type, and the UE may transmit the NAS message on an SRB, or indicate an SRB on which the NAS message is to be transmitted, to indicate the NAS-X connection type.

In option 7, different RRC connection instances may be used for the different NAS-X connections at the same time. For example, different RRC connection instances may be associated with different NAS-X connections and/or different NFs. The UE may utilize an RRC connection instance for transmission of a NAS-X message to indicate a target NAS-X connection and/or a target NF for the NAS-X message.

NF identifier (ID) provision approach may be implemented (i.e. NF ID is carried in the RRC message to help RAN node identify the NAS-X connection and the target NF). An NF ID can be allocated by RAN Node or in NAS-X context, or predefined in specification. for example, a UE may have or be provided with NF IDs that identify NAS-X connections and/or NFs with which the UE may establish NAS-X connections. The NF IDs may be allocated by the base station, may be included in a NAS-X context received by the UE, or may be defined by a specification associated with UEs. The UE may generate NAS messages with NF IDs to indicate the target NAS-X connection and/or the target NF for the NAS messages.

RAN node operation may include the following. Based on the identification on the NAS-X connection, RAN node can establish the connections to the corresponding NF (if the NAS-X connection is not established in network interface before) and forward the message to that NF. For example, a base station may determine based on the indications from one or more of the options above for NAS-X connection identification a target NAS-X connection and/or a target NF for NAS messages. The base station may forward the NAS message on the target NAS-X connection and/or to the target NF based on the indication. In the instance that a NAS-X connection has not been established previously, the base station may establish the NAS-X connection with the target NF.

The options for NAS-X connection identification are described further below.

### NAS-X Connection Identification in RAN Node: AS Impact

For option 1, an explicit indication may be included in the RRC message to identify the NAS-X connection. In an RRC message for NAS message transmission, the RRC message may include the two fields, an NAS Type field and a CN entity info field. The NAS Type field may be used to differentiate the NAS-X types (i.e., mobility management (MM)/SM/UE policy like functions). The CN entity info field may be to carry the specific information of one specific NF. The CN entity info field can carry the NF ID or address info of the target NF, or carry the assistance info to help RAN to select/forward the NAS message (e.g. slicing info, service info).

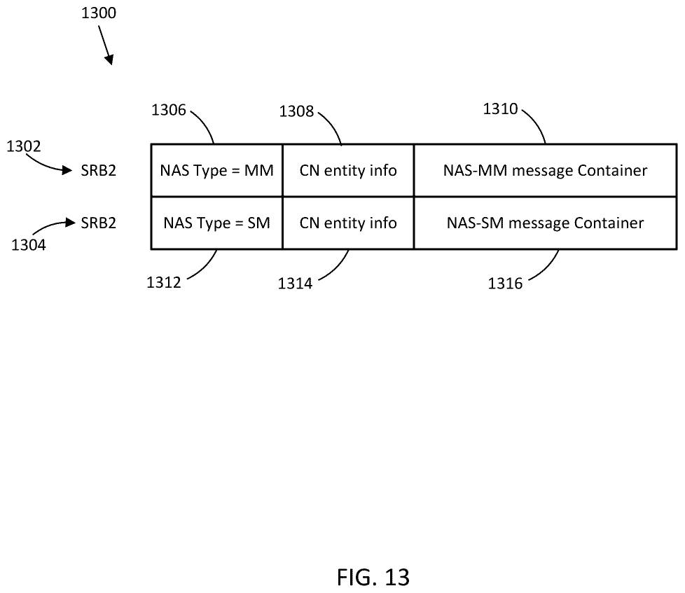

FIG. 13 illustrates example message arrangements 1300 for option 1 in accordance with some embodiments. For example, the message arrangements 1300 illustrate an example of NAS message contents and transmission information in accordance with option 1. The NAS messages may be RRC messages.

The message arrangements 1300 include a first message arrangement 1302 and a second message arrangement 1304 in the illustrated embodiment. The first message arrangement 1302 illustrates an example of message contents and transmission information of a first NAS message and the second message arrangement 1304 illustrates an example of message contents and transmission information of a second NAS message.

The first message arrangement 1302 may include an NAS type field 1306, a CN entity info field 1308, and a message container field 1310 (which is a NAS-MM message container field in the illustrated embodiment). The NAS type field 1306 may indicate a NAS-X type (such as a mobility management (MM) type, an SM type, a UE policy type, and/or other types of functions) for the first NAS message. In the illustrated embodiment, the NAS type field 1306 indicates that the NAS message is an MM type message.

The CN entity info field 1308 may include information indicating an NF for the NAS message. The CN entity info field 1308 may include an NF ID for a target NF of the NAS message, address information of the target NF of the NAS message, and/or information that assists a base station in determining a target NF of the NAS message. In some embodiments, the CN entity info field 1308 may include a target CN entity ID and/or address for the target NF.

The message container field 1310 may include the data to be transmitted via the NAS message. For example, the message container field 1310 may include data related to MM in the illustrated embodiment.

The second message arrangement 1304 may include an NAS type field 1312, a CN entity info field 1314, and a message container field 1316 (which is a NAS-SM container field in the illustrated embodiment). The NAS type field 1312 may include the features of the NAS type field 1306, the CN entity info field 1314 may include the features of the CN entity info field 1308, and the message container field 1316 may include the features of the message container field 1310. In the illustrated embodiment, the NAS type field 1312 indicates that the NAS message is an SM type message. Additionally, the message container field 1316 may include data related to SM.

A UE (such as the UE 2900 (FIG. 29)) may generate the first message corresponding to the first message arrangement 1302 and the second message corresponding to the second message arrangement 1304. The UE may transmit the first message and the second message to a base station. The UE may transmit the first message and the second message via a same SRB or different SRBs. In the illustrated embodiment, the first message and the second message are both transmitted on SRB2.

The base station may determine a target NAS-X connection and/or a target NF for the first message based on the information within the NAS type field 1306 and/or the information within the CN entity info field 1308. Further, the base station may determine a target NAS-X connection and/or a target NF for the second message based on the information within the NAS type field 1312 and/or the information within the CN entity info field 1314. The base station may forward the first message to the determined target NAS-X connection and/or the target NF for the first message, and may forward the second message to the determined target NAS-X connection and/or the target NF for the second message.

For option 2, SRB level NAS-X connection identification may be implemented. A RAN may establish the different SRBs for the NAS messages of different NAS-X connections. The RAN can be based on the SRB ID to identify the NAS-X connection (type). As an example, SRB #2 may be for AMF, SRB #3 may be for SMF, SRB #4 may be for PCF. The mapping between SRB ID and NAS connection (type) can be predefined in a specification related to NAS messages or configured by network.

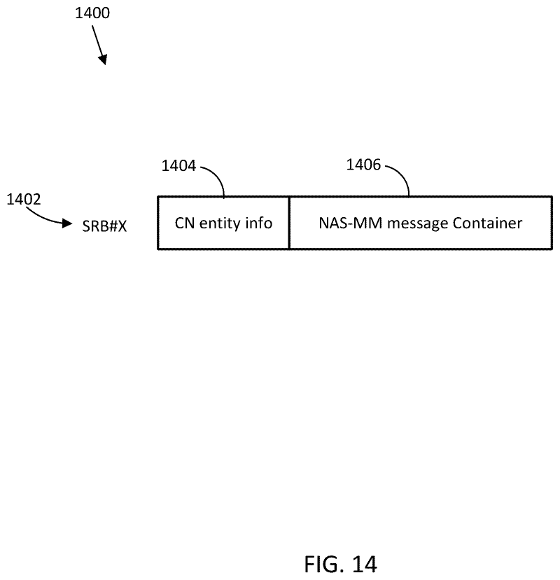

FIG. 14 illustrates an example message arrangement 1400 for option 2 in accordance with some embodiments. For example, the message arrangement 1400 illustrates an example of NAS message contents and transmission information in accordance with option 2. The NAS messages may be RRC messages.

The message arrangement 1400 may include a first message arrangement 1402. The first message arrangement 1402 illustrates an example of message contents and transmission information for a first NAS message.

The first message arrangement 1402 may include a CN entity info field 1404 and a message container field 1406. The CN entity info field 1404 may provide information related to an NF for the first NAS message. In some embodiments, the CN entity info field 1404 may include a target CN entity ID for a target NF, an address for a target NF, and/or critical information for identifying a target NF for the first message. The message container field 1406 may include data to be transmitted via the NAS message. For example, the message container field 1406 may include data related to MM in the illustrated embodiment.

The first message may be transmitted to a base station via an SRB corresponding to a target NAS-X connection and/or a target NF for the first message. For example, the UE may determine an SRB to be utilized for transmission of the first message based on a target NAS-X connection and/or a target NF for the first message. A mapping for determining which SRBs correspond to which NAS-X connections and/or NFs may be provided to the UE by the network (such as via the base station) or may be defined in a specification related to NAS messaging. The UE may transmit the first message via the determined SRB or indicate the determined SRB on which the first message is to be transmitted. In the illustrated embodiment, the first message is represented as being transmitted via SRB #X.

The base station may identify the first message received from the UE and determine an SRB on which the first message was received. The base station may determine a target NAS-X connection and/or a target NF for the first message based on the SRB on which the first message was received. A mapping for determining which SRBs correspond to which NAS-X connections and/or NFs may be provided to the base station by the network (such as by the CN of the network) or may be defined in a specification related to NAS messaging. The base station may forward the first message to the determined target NAS-X connection and/or to the determined target NF.

For option 3, RLC bearer/LCH level NAS-X connection identification may be implemented. Similar to option 2, to save SRB ID resources, network can allocate different LCHs for the different NAS-connections.

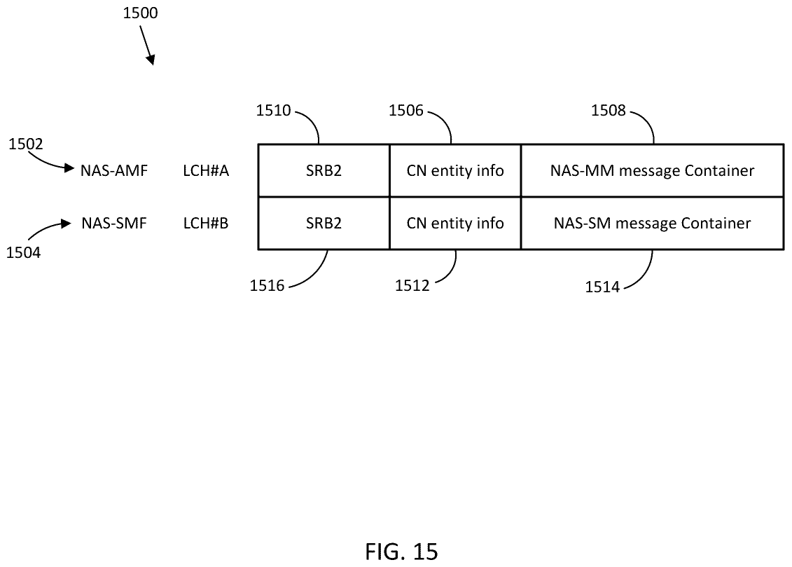

FIG. 15 illustrates example message arrangements 1500 for option 3 in accordance with some embodiments. For example, the message arrangements 1500 illustrate an example of NAS message contents and transmission information in accordance with option 3. The NAS messages may be RRC messages.

The message arrangements 1500 includes a first message arrangement 1502 and a second message arrangement 1504 in the illustrated embodiment. The first message arrangement 1502 illustrates an example of message contents and transmission information of a first NAS message and the second message arrangement 1504 illustrates an example of message contents and transmission information of a second NAS message.

The first message arrangement 1502 may include a CN entity info field 1506, and a message container field 1508 (which is an NAS-MM message container field in the illustrated embodiment). The CN entity info field 1506 may include a target CN entity ID and/or address for a target NF in some embodiments. The message container field 1508 may include the data to be transmitted via the NAS message. For example, the message container field 1508 may include data related to MM in the illustrated embodiment. In some embodiments, the first message arrangement 1502 may include an SRB field 1510. The SRB field 1510 may include an indication of the SRB to be utilized for transmitting the first message.

The second message arrangement 1504 may include a CN entity info field 1512, and a message container field 1514 (which is an NAS-SM message container field in the illustrated embodiment). The CN entity info field 1512 may include a target CN entity ID and/or address for a target NF in some embodiments. The message container field 1514 may include the data to be transmitted via the NAS message. For example, the message container field 1514 may include data related to MM in the illustrated embodiment. In some embodiments, the second message arrangement 1504 may include an SRB field 1516. The SRB field 1516 may include an indication of the SRB to be utilized for transmitting the first message.

The messages may be associated with a LCH corresponding to a target NAS-X connection and/or a target NF for the messages. For example, the UE may determine an LCH to be utilized for transmission of the messages based on a target NAS-X connection and/or a target NF for the messages. A mapping for determining which LCHs correspond to which NAS-X connections and/or NFs may be provided to the UE by the network (such as via the base station) or may be defined in a specification related to NAS messaging. The UE may associate the messages with the determined LCH or indicate the determined LCH with which the messages are to be associated.

In the illustrated embodiment, the first message is associated with LCH #A as indicated by the first message arrangement 1502. LCH #A corresponds to the NAS-AMF connection in the illustrated embodiment. Accordingly, the UE associating the first message with LCH #A may indicate that the first message is to be transmitted via the NAS-AMF connection and/or is to be provided to the AMF.

In the illustrated embodiment, the second message is associated with LCH #B as indicated by the second message arrangement 1504. LCH #B corresponds to the NAS-SMF connection in the illustrated embodiment. Accordingly, the UE associating the second message with LCH #B may indicate that the second message is to be transmitted via the NAS-AMF connection and/or is to be provided to the AMF.

The UE may transmit the first message and the second message to the base station. The base station may determine which LCH each of the messages are associated with. For example, the base station may determine that the first message is associated with LCH #A and the second message is associated with LCH #B in the illustrated embodiment. Further, the base station may determine the NAS-X connection and/or the NF associated with the determined LCH. The base station may forward the messages via the determined NAS-X connection and/or to the determined NF. For example, the base station may forward the first message via the NAS-AMF connection and/or to the AMF, and may forward the second message via the NAS-SMF connection and/or to the SMF in the illustrated embodiment.

Option 4 may be a combination of option 1 and option 2. Option 4 may use an SRB to identify the NAS-X connection type similar to option 2. Further, option 4 may use an explicit indication in an RRC message to identify one special NAS-X connection of the same type similar to option 1.

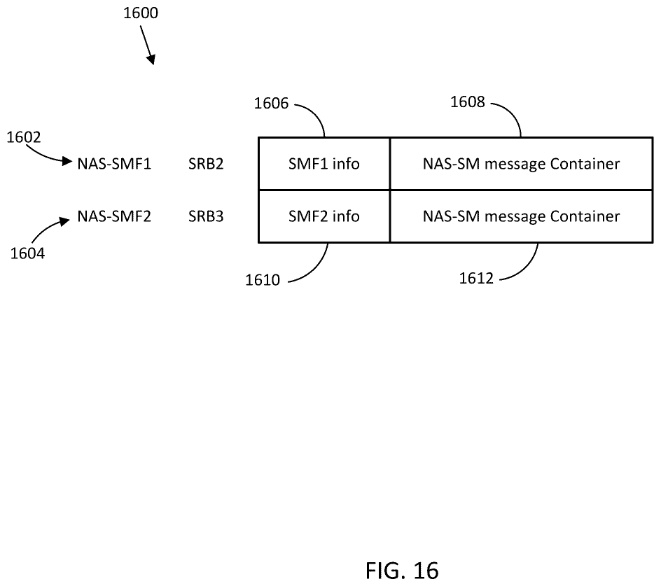

FIG. 16 illustrates example message arrangements 1600 for option 4 in accordance with some embodiments. For example, the message arrangements 1600 illustrate an example of NAS message contents and transmission information in accordance with option 4. The NAS messages may be RRC messages.

The message arrangements 1600 include a first message arrangement 1602 and a second message arrangement 1604 in the illustrated embodiment. The first message arrangement 1602 illustrates an example of message contents and transmission information of a first NAS message and the second message arrangement 1604 illustrates an example of message contents and transmission information of a second NAS message.

The first message arrangement 1602 may include a CN entity info field 1606, and/or a message container field 1608 (which is a NAS-MM message container field in the illustrated embodiment). The CN entity info field 1606 may include information indicating an NAS-X connection of a type for the NAS message, wherein the type matches a type indicated by an SRB related to the NAS message (as described further below). The CN entity info field 1606 may include an NF ID for a target NF of the NAS message, and/or address information of the target NF of the NAS message. In some embodiments, the CN entity info field 1606 may include a target CN entity ID and/or address for the target NF.

The message container field 1608 may include the data to be transmitted via the NAS message. For example, the message container field 1608 may include data related to SM in the illustrated embodiment.

The first message may be transmitted to a base station via an SRB corresponding to a target NAS-X connection type for the first message. For example, the UE may determine an SRB to be utilized for transmission of the first message based on a target NAS-X connection type for the first message. A mapping for determining which SRBs correspond to which NAS-X connection types may be provided to the UE by the network (such as via the base station) or may be defined in a specification related to NAS messaging. The UE may transmit the first message via the determined SRB or indicate the determined SRB on which the first message is to be transmitted. In the illustrated embodiment, the first message is represented as being transmitted via SRB2, which corresponds to an NAS-SMF1 connection.

The base station may identify the first message received from the UE and determine an SRB on which the first message was received. The base station may determine a target NAS-X connection type based on the SRB on which the first message was received. A mapping for determining which SRBs correspond to which NAS-X connection type may be provided to the base station by the network (such as by the CN of the network) or may be defined in a specification related to NAS messaging. The base station may identify an indication of a target NAS-X connection of the NAS-X connection type from the CN entity info field 1706, and may determine the target NAS-X connection and/or the target NF based on the indication. The base station may forward the first message to the determined target NAS-X connection and/or to the determined target NF. For example, the base station may forward the first message on the NAS-SMF1 connection and/or forward the first message to an SMF1 in the illustrated embodiment.

The second message may be transmitted to a base station via an SRB corresponding to a target NAS-X connection type for the second message. For example, the UE may determine an SRB to be utilized for transmission of the second message based on a target NAS-X connection type for the second message. A mapping for determining which SRBs correspond to which NAS-X connection types may be provided to the UE by the network (such as via the base station) or may be defined in a specification related to NAS messaging. The UE may transmit the second message via the determined SRB or indicate the determined SRB on which the first message is to be transmitted. In the illustrated embodiment, the second message is represented as being transmitted via SRB3, which corresponds to an NAS-SMF2 connection.

The base station may identify the second message received from the UE and determine an SRB on which the second message was received. The base station may determine a target NAS-X connection type based on the SRB on which the second message was received. A mapping for determining which SRBs correspond to which target NAS-X connection type may be provided to the base station by the network (such as by the CN of the network) or may be defined in a specification related to NAS messaging. The base station may identify an indication of a target NAS-X connection of the NAS-X connection type from the CN entity info field 1712, and may determine the target NAS-X connection and/or the target NF based on the indication. The base station may forward the second message to the determined target NAS-X connection and/or to the determined target NF. For example, the base station may forward the second message on the NAS-SMF2 connection and/or forward the second message to an SMF2 in the illustrated embodiment.

Option 5 may be a combination of option 1 and option 3. Option 5 may use an LCH to identify the NAS-X connection type similar to option 3. Option 5 may use explicit indication in RRC message to identify one special NAS-X connection of the same type similar to option 1.

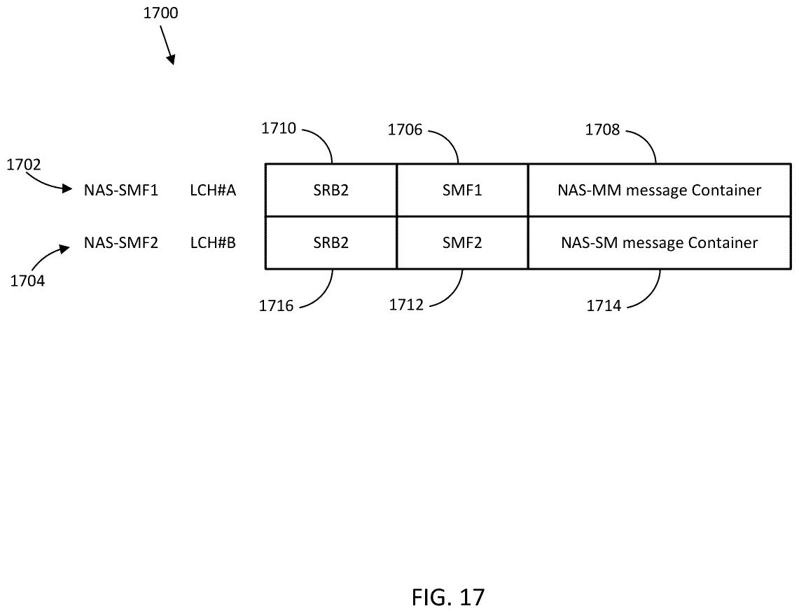

FIG. 17 illustrates example message arrangements 1700 for option 5 in accordance with some embodiments. For example, the message arrangements 1700 illustrate an example of NAS message contents and transmission information in accordance with option 5. The NAS messages may be RRC messages.

The message arrangements 1700 include a first message arrangement 1702 and a second message arrangement 1704 in the illustrated embodiment. The first message arrangement 1702 illustrates an example of message contents and transmission information of a first NAS message and the second message arrangement 1704 illustrates an example of message contents and transmission information of a second NAS message.

The first message arrangement 1702 may include a CN entity info field 1706, and/or a message container field 1708 (which is a NAS-MM message container field in the illustrated embodiment). The CN entity info field 1706 may include information indicating an NAS-X connection of a type for the NAS message, wherein the type matches a type indicated by an SRB related to the NAS message (as described further below). The CN entity info field 1706 may include an NF ID for a target NF of the NAS message, and/or address information of the target NF of the NAS message. In some embodiments, the CN entity info field 1706 may include a target CN entity ID and/or address for the target NF.

The message container field 1708 may include the data to be transmitted via the NAS message. For example, the message container field 1708 may include data related to SM in the illustrated embodiment.

In some embodiments, the first message arrangement 1702 may include an SRB field 1710. The SRB field 1710 may indicate an SRB on which the first message is to be transmitted. In the illustrated embodiment, the SRB field 1710 indicates that the first message is to be transmitted on SRB2.

The second message arrangement 1704 may include a CN entity info field 1712, and/or a message container field 1714 (which is a NAS-SM message container field in the illustrated embodiment). The CN entity info field 1712 may include information indicating an NAS-X connection of a type for the NAS message, wherein the type matches a type indicated by an LCH related to the NAS message (as described further below). The CN entity info field 1712 may include an NF ID for a target NF of the NAS message, and/or address information of the target NF of the NAS message. In some embodiments, the CN entity info field 1712 may include a target CN entity ID and/or address for the target NF.

The message container field 1714 may include the data to be transmitted via the NAS message. For example, the message container field 1714 may include data related to SM in the illustrated embodiment.

In some embodiments, the second message arrangement 1704 may include an SRB field 1716. The SRB field 1716 may indicate an SRB on which the first message is to be transmitted. In the illustrated embodiment, the SRB field 1716 indicates that the first message is to be transmitted on SRB2.

The first message may be associated with an LCH corresponding to a target NAS-X connection type for the first message. For example, the UE may determine an LCH to be utilized for the first message based on a target NAS-X connection type for the first message. A mapping for determining which LCHs correspond to which NAS-X connection types may be provided to the UE by the network (such as via the base station) or may be defined in a specification related to NAS messaging. The UE may associate the first message with the determined LCH or indicate the determined LCH with which the first message is to be associated. In the illustrated embodiment, the first message is represented as being associated with LCH #A, which corresponds to an NAS-SMF1 connection.

The base station may identify the first message received from the UE and determine an LCH associated with the first message. The base station may determine a target NAS-X connection type for the first message based on the LCH associated with the first message. A mapping for determining which LCHs correspond to which NAS-X connection types may be provided to the base station by the network (such as by the CN of the network) or may be defined in a specification related to NAS messaging. The base station may identify an indication of a target NAS-X connection of the NAS-X connection type from the CN entity info field 1706, and may determine the target NAS-X connection and/or the target NF based on the indication. The base station may forward the first message to the determined target NAS-X connection and/or to the determined target NF. For example, the base station may forward the first message on the NAS-SMF1 connection and/or forward the first message to an SMF1 in the illustrated embodiment.

The second message may be associated with an LCH corresponding to a target NAS-X connection type for the second message. For example, the UE may determine an LCH to be utilized for the second message based on a target NAS-X connection type for the first message. A mapping for determining which LCHs correspond to which NAS-X connection types may be provided to the UE by the network (such as via the base station) or may be defined in a specification related to NAS messaging. The UE may associate the second message with the determined LCH or indicate the determined LCH with which the first message is to be associated. In the illustrated embodiment, the second message is represented as being associated with LCH #B, which corresponds to an NAS-SMF2 connection.

The base station may identify the second message received from the UE and determine an LCH associated with the second message. The base station may determine a target NAS-X connection type for the second message based on the LCH associated with the first message. A mapping for determining which LCHs correspond to which NAS-X connection types may be provided to the base station by the network (such as by the CN of the network) or may be defined in a specification related to NAS messaging. The base station may identify an indication of a target NAS-X connection of the NAS-X connection type from the CN entity info field 1712, and may determine the target NAS-X connection and/or the target NF based on the indication. The base station may forward the second message to the determined target NAS-X connection and/or to the determined target NF. For example, the base station may forward the second message on the NAS-SMF2 connection and/or forward the second message to an SMF2 in the illustrated embodiment.

Option 6 may be a combination of option 2 and option 3. Option 6 may use SRB to identify the NAS-X connection type similar to option 2. Further, option 6 may use LCH to identify the NAS-X connection of the same type similar to option 3.

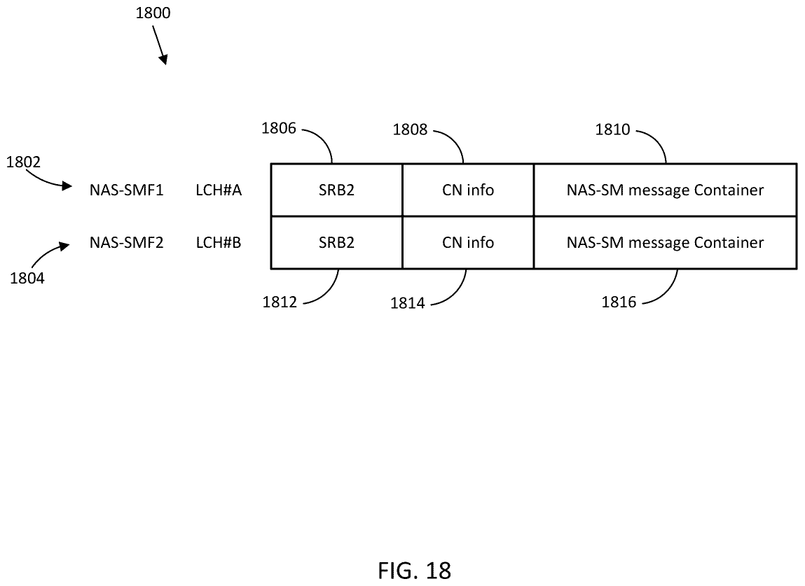

FIG. 18 illustrates example message arrangements 1800 for option 6 in accordance with some embodiments. For example, the message arrangements 1800 illustrate an example of NAS message contents and transmission information in accordance with option 6. The NAS messages may be RRC messages.

The message arrangements 1800 include a first message arrangement 1802 and a second message arrangement 1804 in the illustrated embodiment. The first message arrangement 1802 illustrates an example of message contents and transmission information of a first NAS message and the second message arrangement 1804 illustrates an example of message contents and transmission information of a second NAS message.

The first message arrangement 1802 may include an SRB field 1806, a CN entity info field 1808, and/or a message container field 1810 (which is a NAS-SM message container field in the illustrated embodiment). The SRB field 1806 may include an indication of an SRB on which the first message is to be transmitted. The SRB indicated in the SRB field 1806 may correspond to a NAS-X connection type for the first message. In the illustrated embodiment, the SRB field 1806 indicates SRB2 as the SRB to be utilized for the first message. SRB2 corresponds to an NAS-SMF type connection in the illustrated embodiment.

The CN entity info field 1808 may include an NF ID for a target NF of the NAS message, and/or address information of the target NF of the NAS message. In some embodiments, the CN entity info field 1808 may include a target CN entity ID and/or address for the target NF.

The message container field 1810 may include the data to be transmitted via the NAS message. For example, the message container field 1810 may include data related to SM in the illustrated embodiment.

The second message arrangement 1804 may include an SRB field 1812, a CN entity info field 1814, and/or a message container field 1816 (which is a NAS-SM message container field in the illustrated embodiment). The SRB field 1812 may include an indication of an SRB on which the second message is to be transmitted. The SRB indicated in the SRB field 1812 may correspond to a NAS-X connection type for the second message. In the illustrated embodiment, the SRB field 1812 indicates SRB2 as the SRB to be utilized for the second message. SRB2 corresponds to an NAS-SMF type connection in the illustrated embodiment.

The CN entity info field 1814 may include an NF ID for a target NF of the NAS message, and/or address information of the target NF of the NAS message. In some embodiments, the CN entity info field 1814 may include a target CN entity ID and/or address for the target NF.

The message container field 1816 may include the data to be transmitted via the NAS message. For example, the message container field 1816 may include data related to SM in the illustrated embodiment.

The first message may be associated with an LCH corresponding to a target NAS-X connection and/or a target NF for the first message. For example, the UE may determine an LCH to be utilized for the first message based on a target NAS-X connection and/or a target NF for the first message. A mapping for determining which LCHs correspond to which NAS-X connections and/or NFs may be provided to the UE by the network (such as via the base station) or may be defined in a specification related to NAS messaging. The UE may associate the first message with the determined LCH or indicate the determined LCH with which the first message is to be associated. In the illustrated embodiment, the first message is represented as being associated with LCH #A, which corresponds to an NAS-SMF1 connection.

The base station may identify the first message received from the UE and determine an SRB on which the first message was received. The base station may determine a target NAS-X connection type for the first message based on the determined SRB. A mapping for determining which SRBs correspond to which NAS-X connection types may be provided to the base station by the network (such as by the CN of the network) or may be defined in a specification related to NAS messaging. The base station may determine an LCH associated with the first message. A mapping for determining which LCHs correspond to which NAS-X connections and/or NFs may be provided to the base station by the network (such as by the CN of the network) or may be defined in a specification related to NAS messaging. The base station may determine the target NAS-X connection and/or the target NF based on the determined LCH. The base station may forward the first message to the determined target NAS-X connection and/or to the determined target NF. For example, the base station may forward the first message on the NAS-SMF1 connection and/or forward the first message to an SMF1 in the illustrated embodiment.

The second message may be associated with an LCH corresponding to a target NAS-X connection and/or a target NF for the second message. For example, the UE may determine an LCH to be utilized for the second message based on a target NAS-X connection and/or a target NF for the first second. A mapping for determining which LCHs correspond to which NAS-X connections and/or NFs may be provided to the UE by the network (such as via the base station) or may be defined in a specification related to NAS messaging. The UE may associate the second message with the determined LCH or indicate the determined LCH with which the second message is to be associated. In the illustrated embodiment, the second message is represented as being associated with LCH #B, which corresponds to an NAS-SMF2 connection.

The base station may identify the second message received from the UE and determine an SRB on which the second message was received. The base station may determine a target NAS-X connection type for the second message based on the determined SRB. A mapping for determining which SRBs correspond to which NAS-X connection types may be provided to the base station by the network (such as by the CN of the network) or may be defined in a specification related to NAS messaging. The base station may determine an LCH associated with the second message. A mapping for determining which LCHs correspond to which NAS-X connections and/or NFs may be provided to the base station by the network (such as by the CN of the network) or may be defined in a specification related to NAS messaging. The base station may determine the target NAS-X connection and/or the target NF based on the determined LCH. The base station may forward the second message to the determined target NAS-X connection and/or to the determined target NF. For example, the base station may forward the second message on the NAS-SMF2 connection and/or forward the second message to an SMF2 in the illustrated embodiment.

### NAS-X Connection Identification in RAN Node: NF ID in RRC Message

Usage of NF ID may be implemented in a NAS-X connection identification approach in some embodiments. NF ID may be carried in the RRC message to help RAN node identify the NAS-X connection and target NF. For example, a NAS message (which can be an RRC message) may include an NF ID that can be utilized by a base station to identify a target NAS-X connection and/or a target NF for the NAS message.

A UE can acquire the NF ID via any of 3 methods. For method 1, an NF ID may be allocated by a RAN node. When a new NAS-X connection is requested to be established, gNB allocate a new NF ID for the NAS-X connection. For example, a UE may transmit a request to a base station for a new NAS-X connection to be established with an NF. The base station may provide the UE with a NF ID corresponding to the NAS-X connection that is established based on the request. As an example, if a UE initiates an NAS-SMF connection to the network, the UE can inform the gNB the reason is for NAS-SMF connection, and gNB can allocated one NF-ID in the response message to identify this NAS-SMF connection.

For method 2, an NF ID may be provided in NAS-X context and a UE can acquire it from NAS-AMF connection. When the NW provides the other NAS-X context which is used to help establish the NAS-X connection later, the NF-ID may be included in the NAS-X context. When UE initiates or transmits the NAS messages for the NAS-X connection, the NF ID may be carried in the transmitted message. For method 3, the NF ID may be predefined in a specification related to NAS messaging.

### NAS-X Connection Establishment

There may be associations between different NAS-X connections of one UE. For example, a NAS-AMF connection may be an anchor connection for the UE. Other NAS-X connections for the UE may be associated to one NAS-AMF connection for the UE. If there are multiple NAS-AMF connections, the network may choose one AMF as the anchor AMF function.

There may be an establishment order of the multiple NAS-X connections for a UE. The NAS-AMF connection that is the anchor connection may be set up first. The context to establish the NAS-X connections may be provided via NAS-AMF connection.

An MM-Deregistered UE can only perform an NAS-AMF connection. During the NAS-AMF connection, the AMF may provide NAS context of other NAS-X connections via the NAS-AMF connection to the UE. Further, during the NAS-AMF connection, the AMF may provide the NAS context based on UE registered information and the operator's deployment (e.g. connection between AMF and SMFs). The UE may store the NAS-X context and may use the NAS-X context to establish the subsequent NAS-X connections.

The UE may perform NAS-X connections to other NFs if the UE has the configured NAS-X contexts and the NAS event is triggered. For option 1, only RRC-CONNECTED/RRC-INACTIVE UEs with the NAS-AMF connection can initiate the NAS-X connection. UE may release the NAS-X context when the connection is released. For option 2, IDLE UEs can initiate the NAS-X connection (assume the UE in IDLE also keeps the previous NAS-AMF context/connection). The UE may keep the NAS-X context when the connection is released. The NAS-X connection can be established and/or released by itself or by NAS-AMF connection. Option 1 and option 2 for connection establishment are described further below.

### Example 1—Service Request (Option 1)

For option 1, only CONNECTED/INACTIVE UEs with the NAS-AMF connection can initiate the NAS-X connection. When the UE initiates the connection, the UE may first establish the NAS-AMF connection. The AMF may provide the UE with the configuration/context of the NAS-SM connection, and the SMF identifier is optionally included in the context. The UE may store the NAS-SM context, and may provide the NAS message to the SMF via the NAS-SM directly.

The RAN node may forward the NAS-SM messages to the SMF based on two options. For option 1.1, the RAN node may forward the NAS message based on the NF information in the UE RRC message. For example, in UE NAS-SM message, UE may explicitly indicate the SMF-identifier information, and the RAN may forward the message to the SMF accordingly.

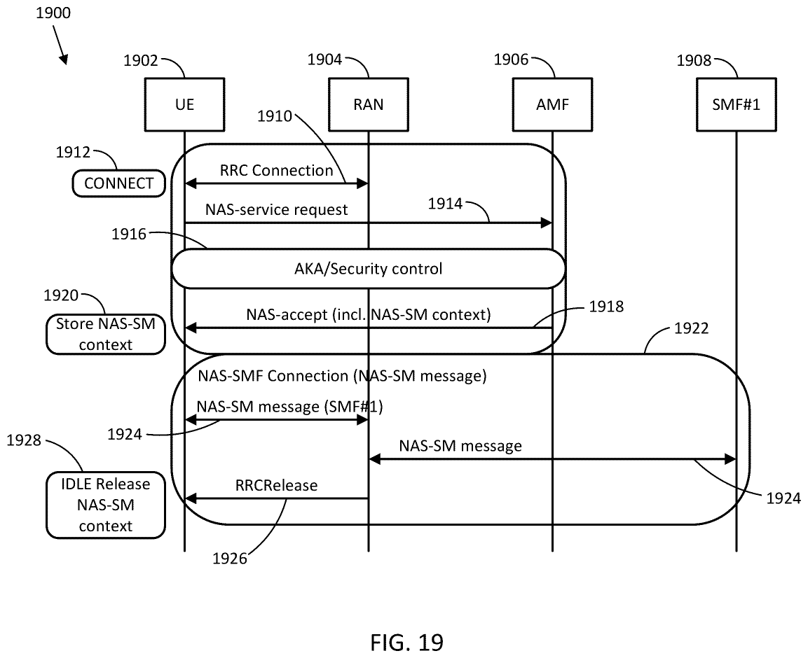

FIG. 19 illustrates an example service request arrangement 1900 for option 1.1 in accordance with some embodiments. The service request arrangement 1900 illustrates examples messages and operations that may be performed to establish an NAS-X connection in accordance with option 1.1.

The service request arrangement 1900 may include a UE 1902, a base station 1904, an AMF 1906, and/or an SMF 1908. In other embodiments, the service request arrangement 1900 may include the UE 1902, the base station 1904, and/or one or more NFs of a network with which the UE 1902 is establishing a connection. The UE 1902 may include one or more of the features of the UE 2900 (FIG. 29). The base station 1904 may include one or more of the features of the gNB 3000 (FIG. 30). The AMF 1906 may be an AMF of a network and the SMF 1908 may be an SMF of the network.

The UE 1902 may begin by establishing an RRC connection with the base station 1904 via an RRC connection operation 1910. The UE 1902 may establish a connection with the base station 1904 as indicated by connect indication 1912.

The UE 1902 may transmit an NAS-service request 1914 to the AMF 1906 via the base station 1904. The NAS-service request 1914 may include a request for establishment of an NAS-X connection with one or more NFs of the network. In the illustrated embodiment, the request may be for establishment of a NAS-SMF connection with the SMF 1908.

The AMF 1906 may perform an authentication and key agreement (AKA) and/or security control operation 1916 with the UE 1902 determine whether the UE 1902 is authorized to access the network and/or the requested NFs. The AKA and/or security control operation 1916 may be performed in response to reception of the NAS-service request 1914.

The AMF 1906 may transmit a NAS-accept message 1918 to the UE 1902. The NAS-accept message 1918 may be transmitted in response to the AMF 1906 determining that the UE 1902 is authorized to access the network and/or the requested NFs based on the AKA and/or the security control operation 1916. The NAS-accept message 1918 may result in a NAS-AMF connection to be established between the UE 1902 and the AMF 1906.

The NAS-accept message 1918 may include NAS-X context for the NAS-X connections requested by the UE 1902 in the NAS-service request. For example, the NAS-X context includes NAS-SM context in the illustrated embodiment based on the UE 1902 requesting a NAS-SM connection with the SMF 1908. In some embodiments, the NAS-X context may include one or more IDs for the NAS-X connections requested by the UE 1902. In the illustrated embodiment, the NAS-X context may include an SMF ID corresponding to the SMF 1908. The UE 1902 may store the NAS-X context, as indicated by the store NAS-SM context indication 1920.

A NAS-SMF connection 1922 may be established between the UE 1902 and the SMF 1908. A NAS-SM message 1924 may be exchanged between the UE 1902 and the base station 1904. For example, the UE 1902 may transmit the NAS-SM message 1924 to the base station 1904.

The base station 1904 may receive the NAS-SM message 1924 from the UE 1902. The base station 1904 may determine a target NAS-X connection and/or a target NF for the NAS-SM message 1924 in accordance with the options for determining a target NAS-X connection and/or a target NF of a NAS message as described throughout this disclosure. In the illustrated embodiment, the base station may determine that the NAS-SMF connection and/or the SMF 1908 is the target of the NAS-SM message 1924. The base station 1904 may forward the NAS-SM message 1924 to the SMF 1908.

The UE 1902 may release a connection with the base station 1904. For example, the base station 1904 may transmit an RRCRelease message 1926 to the UE 1902. The UE 1902 may transition to an IDLE state based on the connection being released, as indicated by IDLE indication 1928. The UE 1902 may release the NAS-SM context as it transitions to the IDLE state.

For option 1.2, the RAN node may be configured with the UE's NAS-X context (e.g. NF-ID/address) of the UE NAS-X connection. The gNB may be based on the information to forward it. For example, the UE may not need to indicate the SMF-identifier information explicitly in the NAS-SM message.

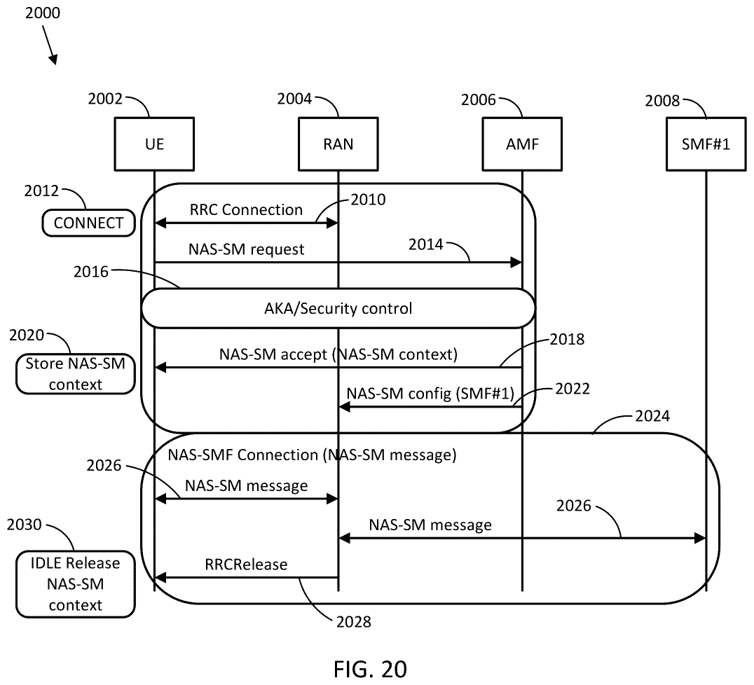

FIG. 20 illustrates an example service request arrangement 2000 for option 1.2 in accordance with some embodiments. The service request arrangement 2000 illustrates example messages and operations that may be performed to establish an NAS-X connection in accordance with option 1.2.

The service request arrangement 2000 may include a UE 2002, a base station 2004, an AMF 2006, and/or an SMF 2008. In other embodiments, the service request arrangement 2000 may include the UE 2002, the base station 2004, and/or one or more NFs of a network with which the UE 2002 is establishing a connection. The UE 2002 may include one or more of the features of the UE 2900 (FIG. 29). The base station 2004 may include one or more of the features of the gNB 3000 (FIG. 30). The AMF 2006 may be an AMF of a network and the SMF 2008 may be an SMF of the network.

The UE 2002 may begin by establishing an RRC connection with the base station 2004 via an RRC connection operation 2010. The UE 2002 may establish a connection with the base station 2004 as indicated by connect indication 2012.

The UE 2002 may transmit an NAS-service request 2014 to the AMF 2006 via the base station 2004. In the illustrated embodiment, the NAS-service request 2014 may be a NAS-SM request. The NAS-service request 2014 may include a request for establishment of an NAS-X connection with one or more NFs of the network. In the illustrated embodiment, the request may be for establishment of a NAS-SMF connection with the SMF 2008.

The AMF 2006 may perform an authentication and key agreement (AKA) and/or security control operation 2016 with the UE 2002 determine whether the UE 2002 is authorized to access the network and/or the requested NFs. The AKA and/or security control operation 2016 may be performed in response to reception of the NAS-service request 2014.

The AMF 2006 may transmit a NAS-accept message 2018 to the UE 2002. The NAS-accept message 2018 may be transmitted in response to the AMF 2006 determining that the UE 2002 is authorized to access the network and/or the requested NFs based on the AKA and/or the security control operation 2016. The NAS-accept message 2018 may result in a NAS-AMF connection to be established between the UE 2002 and the AMF 2006.

The NAS-accept message 2018 may include NAS-X context for the NAS-X connections requested by the UE 2002 in the NAS-service request. For example, the NAS-X context includes NAS-SM context in the illustrated embodiment based on the UE 2002 requesting a NAS-SM connection with the SMF 2008. In some embodiments, the NAS-X context may include one or more IDs for the NAS-X connections requested by the UE 2002. In the illustrated embodiment, the NAS-X context may include an SMF ID corresponding to the SMF 2008. The UE 2002 may store the NAS-X context, as indicated by the store NAS-SM context indication 2020.

The AMF 2006 may transmit an NAS-X config message 2022 to the base station 2004. The NAS-X config message 2022 is a NAS-SM config message in the illustrated embodiment. The NAS-X config message 2022 may cause the base station 2004 to be configured with the NAS-X context for the UE 2002, which can include an NF ID and/or an address for the NF corresponding to the established NAS-X connections. In the illustrated embodiment, the NAS-X context may be NAS-SM context, and may include an NF ID and/or an address corresponding to the SMF 2008. In this option, the UE 2002 may not need to explicitly indicate an NF ID in NAS-X messages transmitted to the base station 2004 due to the base station 2004 being configured with the NAS-X context.

A NAS-SMF connection 2024 may be established between the UE 2002 and the SMF 2008. A NAS-SM message 2026 may be exchanged between the UE 2002 and the base station 2004. For example, the UE 2002 may transmit the NAS-SM message 2026 to the base station 2004.

The base station 2004 may receive the NAS-SM message 2026 from the UE 2002. The base station 2004 may determine a target NAS-X connection and/or a target NF for the NAS-SM message 2026 in accordance with the options for determining a target NAS-X connection and/or a target NF of a NAS message as described throughout this disclosure. For example, the base station 2004 may determine the target NAS-X connection and/or the target NF using options that do not require explicit indication of an NF ID, such as options that utilize SRB bearers, RLC bearers, and/or LCH to indicate the target NAS-X connection, the target NF, and/or the target NAS-X type. In the illustrated embodiment, the base station may determine that the NAS-SMF connection and/or the SMF 2008 is the target of the NAS-SM message 2026. The base station 2004 may forward the NAS-SM message 2026 to the SMF 2008.

The UE 2002 may release a connection with the base station 2004. For example, the base station 2004 may transmit an RRCRelease message 2028 to the UE 2002. The UE 2002 may transition to an IDLE state based on the connection being released, as indicated by IDS indication 2030. The UE 2002 may release the NAS-SM context as it transitions to the IDLE state.

### Example—Service Request (Option 2)

For option 2, IDLE UEs can initiate the NAS-X connection. A UE may have acquired the NAS-X context via NAS-AMF connection which is setup in a previous connection. The UE may keep the NAS-X context when entering IDLE state.

When an IDLE UE initiates the service request, if the UE has the valid NAS-X context (e.g., including security info), the UE may initiate the NAS-X connection towards the network directly. Otherwise, the UE may initiate the NAS-AMF connection to request a NAS-SM connection. During the NAS-X connection, NF #1 may need to inform AMF about the UE connection. During the NAS-X connection, if a UE NAS MM procedure is initiated (e.g., periodic registration procedure, TAU procedure), UE may transmit the message via the default/stored NAS-AMF connection.

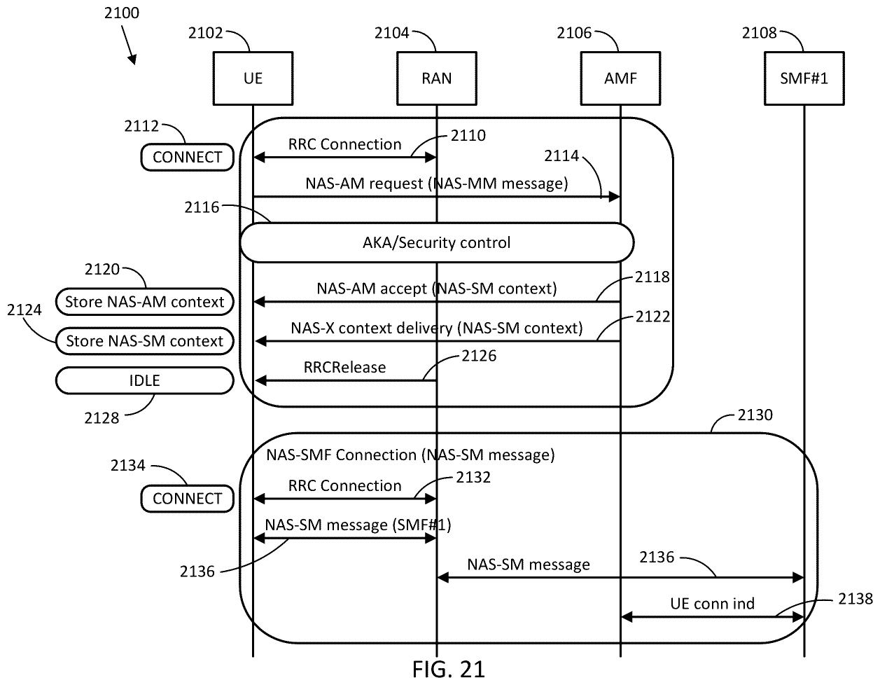

FIG. 21 illustrates an example service request arrangement 2100 for option 2 in accordance with some embodiments. The service request arrangement 2100 illustrates examples messages and operations that may be performed to establish an NAS-X connection in accordance with option 2.

The service request arrangement 2100 may include a UE 2102, a base station 2104, an AMF 2106, and/or an SMF 2108. In other embodiments, the service request arrangement 2100 may include the UE 2102, the base station 2104, and/or one or more NFS of a network with which the UE 2102 is establishing a connection. The UE 2102 may include one or more of the features of the UE 2900 (FIG. 29). The base station 2104 may include one or more of the features of the gNB 3000 (FIG. 30). The AMF 2106 may be an AMF of a network and the SMF 2108 may be an SMF of the network.

The UE 2102 may begin by establishing an RRC connection with the base station 2104 via an RRC connection operation 2110. The UE 2102 may establish a connection with the base station 2104 as indicated by connect indication 2112.

The UE 2102 may transmit an NAS-service request 2114 to the AMF 2106 via the base station 2104. The NAS-service request 2114 may be an NAS-AM request in the illustrated embodiment. The NAS-service request 2114 may include a NAS-MM message. The NAS-service request 2114 may include a request for establishment of an NAS-X connection with one or more NFs of the network. In the illustrated embodiment, the request may be for establishment of an NAS-SMF connection with the SMF 2108.

The AMF 2106 may perform an authentication and key agreement (AKA) and/or security control operation 2116 with the UE 2102 determine whether the UE 2102 is authorized to access the network and/or the requested NFs. The AKA and/or security control operation 2116 may be performed in response to reception of the NAS-service request 2114.

The AMF 2106 may transmit a NAS-accept message 2118 to the UE 2102. The NAS-accept message 2118 may be transmitted in response to the AMF 2106 determining that the UE 2102 is authorized to access the network and/or the requested NFs based on the AKA and/or the security control operation 2116. The NAS-accept message 2118 may result in a NAS-AMF connection to be established between the UE 2102 and the AMF 2106.

The NAS-accept message 2118 may include NAS-X context for the NAS-X connections requested by the UE 2102 in the NAS-service request. For example, the NAS-X context includes NAS-SM context in the illustrated embodiment based on the UE 2102 requesting a NAS-SM connection with the SMF 2108. In some embodiments, the NAS-X context may include one or more IDs for the NAS-X connections requested by the UE 2102. In the illustrated embodiment, the NAS-X context may include an SMF ID corresponding to the SMF 2108. The UE 2102 may store the NAS-X context, as indicated by the store NAS-AM context indication 2120.

The AMF 2106 may transmit a NAS-X context delivery message 2122 to the UE 2102. The NAS-X context delivery message 2122 may include NAS-X context for the NAS-X connections requested by the UE 2102 in the NAS-service request. For example, the NAS-X context includes NAS-SM context in the illustrated embodiment based on the UE 2102 requesting a NAS-SM connection with the SMF 2108. In some embodiments, the NAS-X context may include one or more IDs for the NAS-X connections requested by the UE 2102. In the illustrated embodiment, the NAS-X context may include an SMF ID corresponding to the SMF 2108. The UE 2102 may store the NAS-X context, as indicated by the store NAS-SM context indication 2124.

The UE 2102 may release a connection with the base station 2104. For example, the base station 2104 may transmit an RRCRelease message 2126 to the UE 2102. The UE 2102 may transition to an IDLE state based on the connection being released, as indicated by IDLE indication 2128. The UE 2102 may store the NAS-SM context as it transitions to the IDLE state.

A NAS-SMF connection 2130 may be established between the UE 2102 and the SMF 2108. The UE 2002 may establish an RRC connection with the base station 2004 via an RRC connection operation 2132. The UE 2102 may establish a connection with the base station 2104 as indicated by connect indication 2134.

A NAS-SM message 2136 may be exchanged between the UE 2102 and the base station 2104. For example, the UE 2102 may transmit the NAS-SM message 2136 to the 2104.

The base station 2104 may receive the NAS-SM message 2136 from the UE 2102. The base station 2104 may determine a target NAS-X connection and/or a target NF for the NAS-SM message 2136 in accordance with the options for determining a target NAS-X connection and/or a target NF of a NAS message as described throughout this disclosure. In the illustrated embodiment, the base station may determine that the NAS-SMF connection and/or the SMF 2108 is the target of the NAS-SM message 2136. The base station 2104 may forward the NAS-SM message 2136 to the SMF 2108.

The SMF 2108 may exchange a UE connection indication 2138 with the AMF 2106. In particular, the SMF 2108 may provide a UE connection indication 2138 to the AMF 2106 to indicate that the UE 2102 has established a NAS-SM connection with the SMF 2108.

### NF Entity Selection

In 5G design, AMF selects the target CN entity. Selection may be amongst multiple CN entities of the same NAS-X connection type. CN entity selection can be in UE, gNB, or AMF, based on some information/rule. For example, a UE (such as the UE 2900 (FIG. 29)), a base station (such as the gNB 3000 (FIG. 30)), and/or an AMF may select which CN entity messages are to directed based on information and/or rules. In instances, a network may include multiple NFs of a same type (such as multiple SMF NFs), where the UE, the base station, and/or the AMF may select to which of the multiple NFs each of the messages is to be provided.

The NW may provide the association and/or mapping between NFs and different services and/or slices to the UE or the RAN node via the NAS-AMF connection. For example, different SMFs may be used for different services and/or slices.

For option 1, the CN and/or the AMF may provide the CN entity selection rule and/or information to the RAN node. The UE may inform the gNB about the NAS connection type and the service and/or slice for the selection (e.g., network slice selection assistance information (NSSAI)). The RAN node may select the specific CN entity for connection.

For option 2, the CN and/or AMF may provide the CN entity selection rule and/or information to the UE. The NW can provide the selection rule and/or information via the policy (UE route selection policy (URSP)) or via an AMF connection message. The UE may be based on the trigger event and service and/or slice to select target CN entity and indicate the information to the gNB. The gNB may double check and forward the information.

For option 3, the CN and/or AMF may select the target NF #X directly by itself. For the first UE connection to the network via the NAS-AMF, the network can explicitly indicate the target CN entity to the UE and the gNB for the subsequent NAS connection.

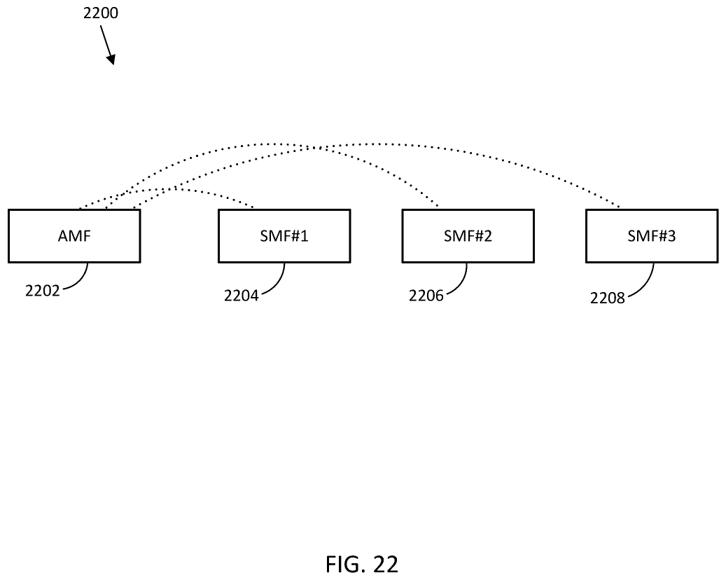

FIG. 22 illustrates example NF arrangement 2200 in accordance with some embodiments. For example, the NF arrangement 2200 illustrates an example of SMF associations in accordance with some embodiments. While the NF arrangement 2200 is illustrated with SMFs, it should be understood that other NFs may be included in other embodiments.

The NF arrangement 2200 may include an AMF 2202, a first SMF 2204, a second SMF 2206, and a third SMF 2208 of a network. The first SMF 2204, the second SMF 2206, and the third SMF 2208 may be associated with the AMF 2202.

Different SMFs may be for different services and/or slices. For example, the first SMF 2204 may be utilized for processing first services and/or slices, the second SMF 2206 may be utilized for processing second services and/or slices, and the third SMF 2208 may be utilized for third services and/or slices. The association may be based on an operator's deployments. For example, the association between the SMFs and the services and/or slices may be dependent on an operator's employment.

For option 1, the CN and/or the AMF 2202 may provide a CN entity selection rule and/or information to the base station. The CN entity selection rule and/or information may indicate which SMF is to be used for which services and/or slices. The UE may inform the base station about the NAS connection, the service, and/or the slice that may be utilized for selection of an SMF for processing the NAS message. The base station may determine the SMF to which the NAS message is to be provided based on the NAS connection, the service, and/or the slice provided by the UE and may provide the NAS message to the SMF via a corresponding NAS-SMF connection.

For option 2, the CN and/or the AMF 2202 may provide a CN entity selection rule and/or information to the UE. The CN entity selection rule and/or information may indicate which SMF is to be used for which services and/or slices. The CN and/or the AMF 2202 may provide the CN entity selection rule and/or information to the UE via a URSP or via an AMF connection message. The UE may select a target SMF for a NAS message based on the CN entity selection rule and/or information. A trigger event may cause the UE to perform the selection and a service and/or slice associated with the NAS message may be used for selecting the target SMF. The UE may indicate the target SMF for the NAS message to the base station. The base station may double check the target SMF and forward the NAS message to the target SMF.

For option 3, the CN and/or the AMF 2202 may select a target SMF for NAS messages from a UE. For a first connection of a UE to the network via an NAS-AMF connection, the network can explicitly indicate the target SMF to the UE and base station for subsequent NAS connections.

### Mobility

As the anchor AMF changes, the associated NAS-X connection may be updated. During an AMF change, the network may update the NAS context of other NAS-connections.

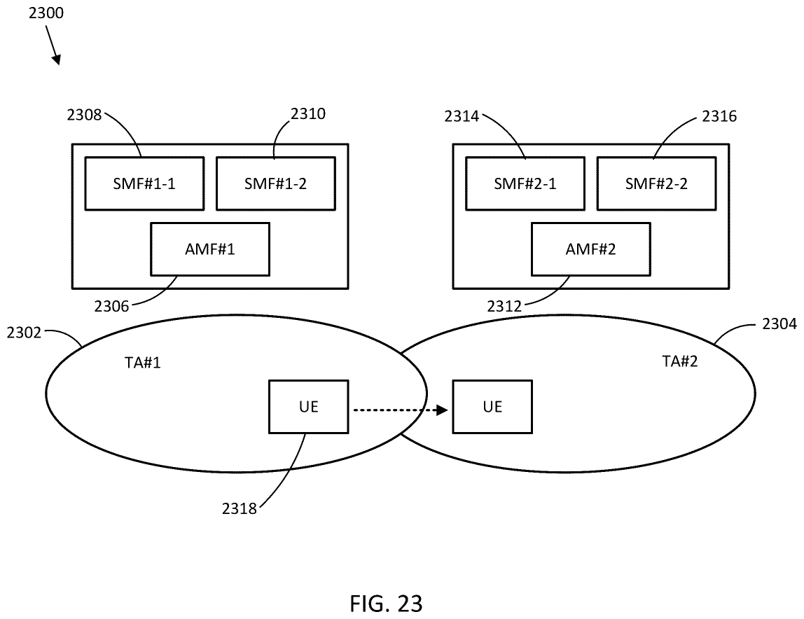

FIG. 23 illustrates an example UE mobility arrangement 2300 in accordance with some embodiments. The UE mobility arrangement 2300 illustrates an example of movement of a UE between different cells.

The UE mobility arrangement 2300 may include one or more cells. In the illustrated embodiment, the UE mobility arrangement 2300 includes a first cell 2302 and a second cell 2304.

The first cell 2302 may be hosted by a first base station connected to a first group of NFs. In the illustrated embodiments, the first cell 2302 has a first AMF 2306, a first SMF 2308, and a second SMF 2310. UEs located in the first cell 2302 may establish NAS-X connections with the first AMF 2306, the first SMF 2308, and/or the second SMF 2310.

The second cell 2304 may be hosted by a second base station connected to a second group of NFs. In the illustrated embodiments, the second cell 2304 has a second AMF 2312, a third SMF 2314, and a fourth SMF 2316. UEs located in the second cell 2304 may establish NAS-X connections with the second AMF 2312, the third SMF 2314, and/or the fourth SMF 2316.

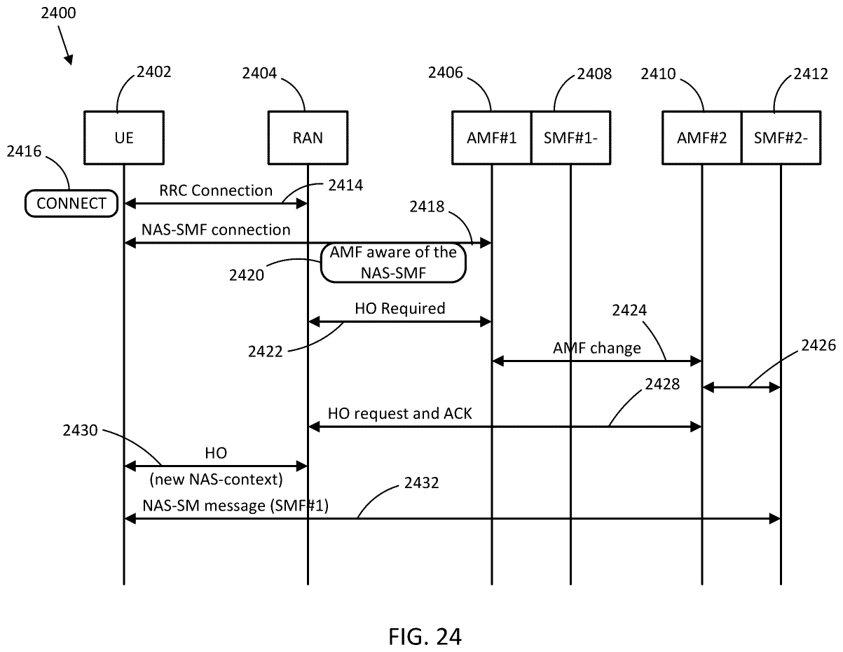

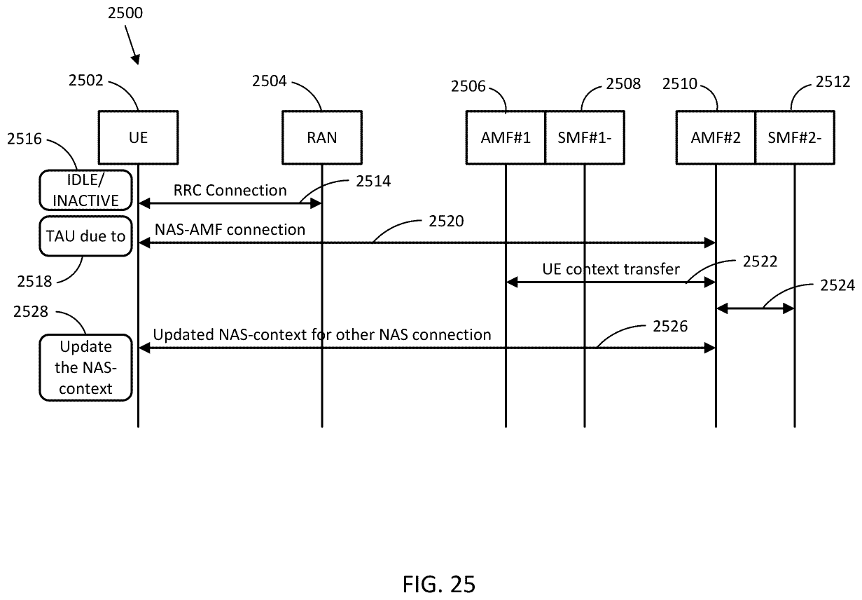

The UE mobility arrangement 2300 may include a UE 2318. The UE may include one or more of the features of the UE 2900 (FIG. 29). The UE 2318 may initially be located within the first cell 2302 and may have established a connection with the first AMF 2306. The UE 2318 may move from within the first cell 2302 to within the second cell 2304. Due to the movement, a handover (HO) operation may be performed to HO the UE connection from the first AMF 2306 to the second AMF 2312. The HO operation may include the signaling illustrated in FIG. 24 or FIG. 25.

FIG. 24 illustrates an example UE HO arrangement 2400 in accordance with some embodiments. The UE HO arrangement 2400 illustrates example signals and operations that may include an HO of a UE in a connected state.

The UE HO arrangement 2400 may include a UE 2402 and a base station 2404. The UE 2402 may include one or more of the features of the UE 2900 (FIG. 29). The base station 2404 may include one or more of the features of the gNB 3000 (FIG. 30).

The UE HO arrangement 2400 may include a first AMF 2406 and a first SMF 2408. The first AMF 2406 and the first SMF 2408 may be associated with a first cell (such as the first cell 2302 (FIG. 23)). The first SMF 2408 may be associated with the first AMF 2406, where the first AMF 2406 may facilitate establishment of a NAS-SMF connection with the first SMF 2408.

The UE HO arrangement 2400 may include a second AMF 2410 and a second SMF 2412. The second AMF 2410 and the second SMF 2412 may be associated with a second cell (such as the second cell 2304 (FIG. 23)). The second SMF 2412 may be associated with the second AMF 2410, where the second AMF 2410 may facilitate establishment of a NAS-SMF connection with the second SMF 2412.

The UE 2402 may begin by establishing an RRC connection with the base station 2404 via an RRC connection operation 2414. The UE 2402 may establish a connection with the base station 2404 as indicated by connect indication 2416.

The UE 2402 may establish a NAS-SMF connection with the first AMF 2406 via the NAS-SMF connection operation 2418. The first AMF 2406 may be aware of the NAS-SMF connection, as indicated by 2420.

The base station 2404 and/or the first AMF 2406 may determine that the UE 2402 is to be handed over to the second AMF 2410. The base station 2404 and/or the first AMF 2406 may determine that the UE 2402 is to be handed over based on the UE 2402 moving from within a first cell (such as the first cell 2302) associated with the first AMF 2406 to within a second cell (such as the second cell 2304) associated with the second AMF 2410. The base station 2404 and the first AMF 2406 may exchange an HO message 2422 to indicate an AMF HO is to be performed.

The first AMF 2406 and the second AMF 2410 may perform an AMF change operation 2424. The AMF change operation 2424 may include indicating to the second AMF 2410 that NAS-X connections of the UE 2402 may be handed over to the second AMF 2410 and NFs associated with the second AMF 2410. In some embodiments, the AMF change operation 2424 may include information related to the UE 2402 and/or the NAS-X connections of the UE 2402.

The second AMF 2410 may exchange information messages 2426 with the second SMF 2412. The second AMF 2410 may exchange the information messages 2426 based on the second AMF 2410 determining that an NAS-X connection is to be established between the UE 2402 and the second SMF 2412. The information messages 2426 may include information related to the second SMF 2412, such as an NF ID corresponding to the second SMF 2412 and/or an address corresponding to the second SMF 2412.

The base station 2404 and the second AMF 2410 perform HO request and acknowledgement (ACK) operations 2428. The HO request and ACK operations 2428 may include the base station 2404 providing an HO request to the second AMF 2410 for HO of the UE 2402 to the second AMF 2410. The HO request and ACK operations 2428 may further include the second AMF 2410 providing an ACK message to the base station 2404 that indicates that the second AMF 2410 will accept HO of the UE 2402. In some embodiments, the ACK message (or another message transmitted from the second AMF 2410 to the base station 2404) may include NAS-context related to the second AMF 2410.

The UE 2402 and the base station 2404 may perform an HO operation 2430. The HO operation 2430 operation may include exchanging information between the UE 2402 and the base station 2404 to handover the UE 2402 to the second AMF 2410. The HO operation 2430 may include the base station 2404 providing NAS-context for the second AMF 2410 to the UE 2402. The NAS-context may facilitate the UE 2402 in establishing NAS-X connections with the second AMF 2410 and/or the second SMF 2412.

The UE 2402 may establish a NAS-SMF connection with the second SMF 2412. The UE may establish the NAS-SMF connection based on the received NAS-context. The UE may transmit a NAS-SM message 2432 to the second SMF 2412 via the NAS-SMF connection. The UE 2402 and/or the base station 2404 may determine that the NAS-SM message 2432 is to be transmitted via the NAS-SMF connection and/or to the second SMF 2412 based on the NAS-context.

FIG. 25 illustrates an example UE HO arrangement 2500 in accordance with some embodiments. The UE HO arrangement 2500 illustrates example signals and operations that may include an HO of a UE in an IDLE or INACTIVE state.

The UE HO arrangement 2500 may include a UE 2502 and a base station 2504. The UE 2502 may include one or more of the features of the UE 2900 (FIG. 29). The base station 2504 may include one or more of the features of the gNB 3000 (FIG. 30).

The UE HO arrangement 2500 may include a first AMF 2506 and a first SMF 2508. The first AMF 2506 and the first SMF 2508 may be associated with a first cell (such as the first cell 2302 (FIG. 23)). The first SMF 2508 may be associated with the first AMF 2506, where the first AMF 2506 may facilitate establishment of a NAS-SMF connection with the first SMF 2508.

The UE HO arrangement 2500 may include a second AMF 2510 and a second SMF 2512. The second AMF 2510 and the second SMF 2512 may be associated with a second cell (such as the second cell 2304 (FIG. 23)). The second SMF 2512 may be associated with the second AMF 2510, where the second AMF 2510 may facilitate establishment of a NAS-SMF connection with the second SMF 2512.

The UE 2502 may begin by establishing an RRC connection with the base station 2504 via an RRC connection operation 2514. The UE 2502 may establish a connection with the base station 2504. The UE 2502 may transition to and/or be in an IDLE or an INACTIVE state at completion of the RRC connection operation 2514, as indicated by the IDLE/INACTIVE indication 2516.

A tracking area update (TAU) may be initiated for the UE 2502, as indicated by TAU indication 2518. The TAU may be initiated due to the UE 2502 moving from within the first cell associated with the first AMF 2506 to within the second cell associated with the second AMF 2510.

The UE 2502 may establish a NAS-SMF connection with the second AMF 2510 via the NAS-SMF connection operation 2520.

The second AMF 2510 and the first AMF 2506 may perform a UE context transfer 2522. The first AMF 2506 may provide UE context related to the UE 2502 as part of the UE context transfer 2522. The first AMF 2506 may provide an indication of the NFs related to the first AMF 2506 with which the UE 2502 established NAS-X connections.

The second AMF 2510 may exchange information messages 2524 with the second SMF 2512. The second AMF 2510 may exchange the information messages 2524 based on the second AMF 2510 determining that an NAS-X connection is to be established between the UE 2502 and the second SMF 2512. The information messages 2524 may include information related to the second SMF 2512, such as an NF ID corresponding to the second SMF 2512 and/or an address corresponding to the second SMF 2512.

The second AMF 2510 may provide an updated NAS-context message 2526 to the UE 2502. The updated NAS-context message 2526 may include updated NAS-context for other NAS connections, where the updated NAS-X context may be for NFs associated with the second AMF 2510. The NAS-context for the UE 2502 may be updated as indicated by the update NAS-context indication 2528.

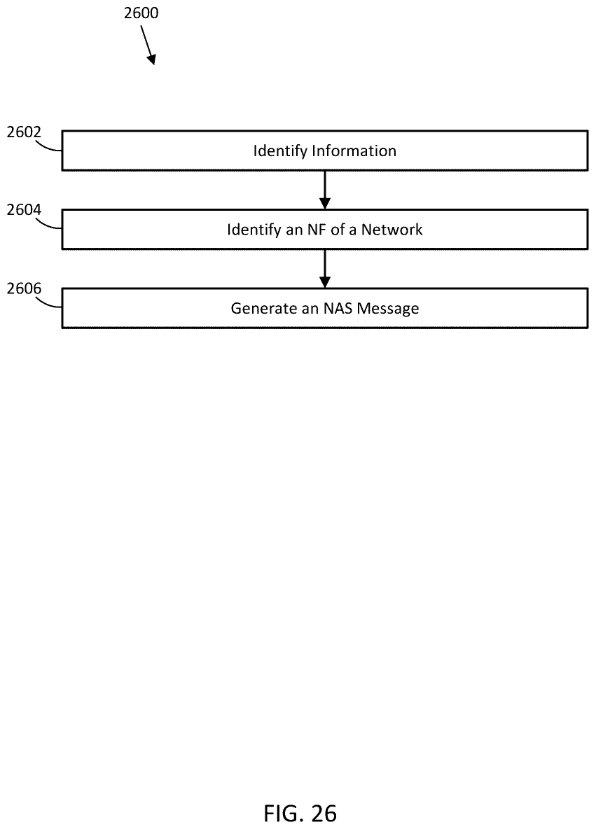

FIG. 26 illustrates an example procedure 2600 for generating a NAS-X message in accordance with some embodiments. The NAS-X connection may indicate a NAS-X connection to be used for transmission of the information to an NF. The procedure 2600 may be performed by a UE, such as the UE 2900 (FIG. 29).

The procedure 2600 may include identifying information in 2602. For example, the UE may identify information, where the information may be for a NAS message to be transmitted to an NF.

The procedure 2600 may include identifying an NF of a network in 2604. For example, the UE may identify an NF of a network to which the information is to be provided.

In some embodiments, the procedure 2600 may include identifying entity selection information received from the network. The NF may be identified based at least in part in part on the entity selection information. In some of these embodiments, the entity selection information may be received via URSP or an AMF connection message.

In some embodiments, identifying the NF may include identifying an indication from the network that indicates the NAS message is to be provided to the NF. The NF may be identified based at least in part on the indication.

The procedure 2600 may include generating an NAS message in 2606. For example, the UE may generate an NAS message to indicate an NAS-X connection to be used for transmission of the information to the NF.

In some embodiments, the NAS message may include an RRC. The RRC message may include an indication of the NAS-X connection. In some of these embodiments, the NAS-X connection may include an NF ID corresponding to the NF. In some of these embodiments, the procedure 2600 may include identifying the NF ID received from a base station or in an NAS-X context.

In some embodiments, generating the NAS message may include indicating an SRB for the transmission to the NF. The SRB may correspond to the NAS-X connection.

In some embodiments, generating the NAS message may include indicating an RLC bearer or an LCH for transmission to the NF. The RLC bearer or LCH may correspond to the NAS-X connection.

In some embodiments, generating the NAS message may include indicating an SRB for the transmission to the NF. The SRB may correspond to the NAS-X type. The NAS message may include an RRC message. The RRC message may include an indication of the NAS-X connection of the NAS-X connection type.

In some embodiments, generating the NAS message may include indicating an LCH for the transmission to the NF. The LCH may correspond to an NAS-X connection type. The NAS message may include an RRC message. The RRC message may include an indication of the NAS-X connection of the NAS-X connection type.

In some embodiments, generating the NAS message may include indicating an SRB for the transmission to the NF. The SRB may correspond to an NAS-X connection type. Generating the NAS message may further include indicating an LCH for the transmission to the NF. The LCH may correspond to the NAS-X connection of the NAS-X connection type.

In some embodiments, generating the NAS message may include indicating an RRC connection instance for the transmission to the NF. The RRC connection instance corresponding to the NAS-X connection.

In some embodiments, generating the NAS message may include indicating an NAS connection type corresponding to the NAS-X and a service or slice corresponding to the NAS-X connection.

While FIG. 26 may arguably imply an order of the operations of the procedure 2600, it should be understood that one or more of the operations may be performed in a different order and/or one or more of the operations may be performed concurrently in embodiments. Further, it should be understood that one or more of the operations may be omitted from and/or one or more additional operations may be added to the procedure 2600 in other embodiments.

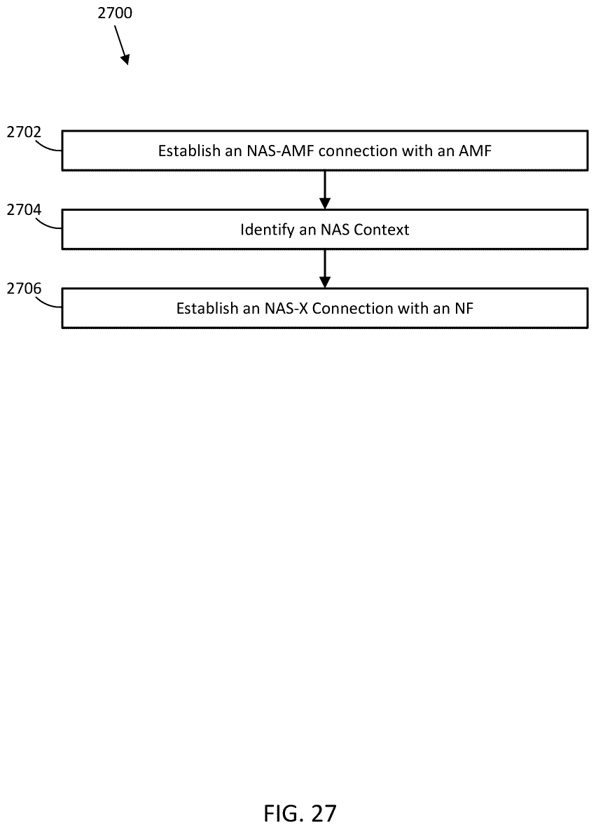

FIG. 27 illustrates an example procedure 2700 for establishing an NAS-X connection in accordance with some embodiments. The procedure 2700 may be performed by a UE, such as the UE 2900 (FIG. 29).

The procedure 2700 may include establishing an NAS-AMF connection with an AMF in 2702. For example, the UE may establish an NAS-AMF connection with an AMF of a network.

The procedure 2700 may include identifying an NAS context. For example, the UE may identify an NAS context received from the AMF via the NAS-AMF connection. In some embodiments, the NAS context may include a configuration for the NAS-X connection. The NAS context may include an NF ID corresponding to the NF in some embodiments.

The procedure 2700 may include establishing an NAS-X connection with an NF. For example, the UE may establish an NAS-X connection with an NF of the network utilizing the NAS context. In some embodiments, the NAS-X connection may be established while the device is in an RRC-connected state or an RRC-inactive state. The NAS-X connection may be established while the device is in an idle state in some embodiments.

In some embodiments, the NAS-AMF connection may be a first NAS-AMF connection. The procedure 2700 may further include establishing a second NAS-AMF connection subsequent to the first NAS-AMF connection. The NAS-X connection may be established via the second NAS-AMF connection.

While FIG. 27 may arguably imply an order of the operations of the procedure 2700, it should be understood that one or more of the operations may be performed in a different order and/or one or more of the operations may be performed concurrently in embodiments. Further, it should be understood that one or more of the operations may be omitted from and/or one or more additional operations may be added to the procedure 2600 in other embodiments.

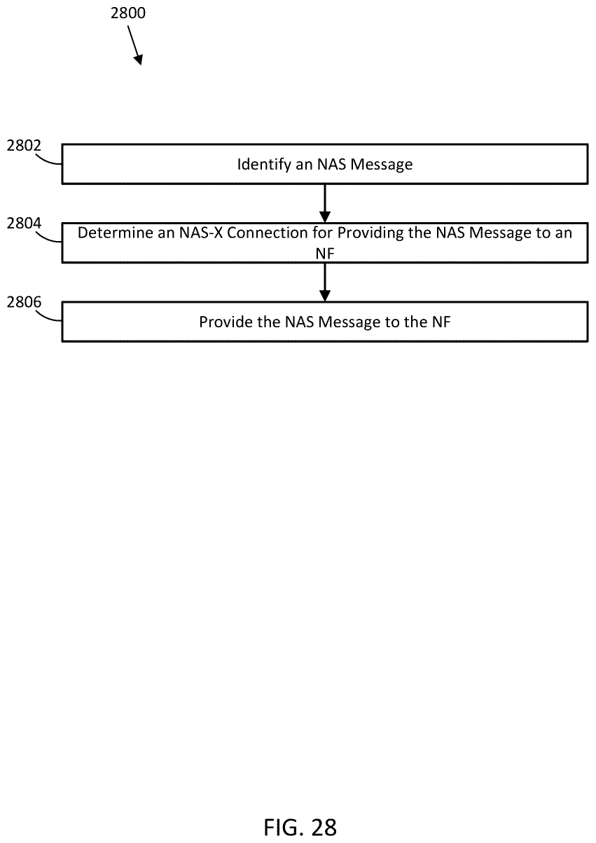

FIG. 28 illustrates an example procedure 2800 for providing an NAS message to an NF in accordance with some embodiments. The NAS message may be provided via an NAS-X connection to the NF. The procedure 2800 may be performed by a base station, such as the gNB 3000 (FIG. 30).

The procedure 2800 may include identifying an NAS message in 2802. For example, the base station may identify an NAS message received from a UE.

The procedure 2800 may include determining an NAS-X connection for providing the NAS message to an NF. For example, the base station may determine an NAS-X connection for providing the NAS message to an NF of a network based at least in part on reception of the NAS message.

In some embodiment, the NAS-X connection may be determined based at least in part on an indication of the NAS-X connection included in the NAS message. The NAS-X connection may include an NF ID corresponding to the NF in some embodiments. In some embodiments, the NAS-X connection may be determined based at least in part on an SRB associated with reception of the NAS message.

In some embodiments, the NAS-X connection may be determined based at least in part on an RLC bearer or an LCH associated with the reception of the NAS message. The NAS-X connection may be determined based at least in part on an SRB associated with the reception of the NAS message that indicates an NAS-X connection type and an indication of the NAS-X connection of the NAS-X connection type from the NAS message in some embodiments.

In some embodiments, the NAS-X connection may be determined based at least in part on an LCH associated with the reception of the NAS message that indicates an NAS-X connection type and an indication of the NAS-X connection of the NAS-X connection of the NAS-X connection type from the NAS message. The NAS-X connection may be determined based at least in part on an SRB associated with the reception of the NAS message that indicates an NAS-X connection type and an LCH associated with the reception of the NAS message that indicates the NAS-X connection of the NAS-X connection type.

In some embodiments, the NAS-X connection may be determined based at least in part on an RRC connection instance associated with the reception of the NAS message. The NAS-X connection may be determined based at least in part on an NAS connection type and a service or a slice indicated by the UE for the NAS message in some embodiments. In some embodiments, the NAS-X connection may be determined based at least in part on an indication received from the network.

The procedure 2800 may include providing the NAS message to the NF in 2806. For example, the base station may provide the NAS message to the NF via the NAS-X connection.

While FIG. 28 may arguably imply an order of the operations of the procedure 2800, it should be understood that one or more of the operations may be performed in a different order and/or one or more of the operations may be performed concurrently in embodiments. Further, it should be understood that one or more of the operations may be omitted from and/or one or more additional operations may be added to the procedure 2800 in other embodiments.

FIG. 29 illustrates an example UE 2900 in accordance with some embodiments. The UE 2900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices. In some embodiments, the UE 2900 may be a RedCap UE or NR-Light UE.

The UE 2900 may include processors 2904, RF interface circuitry 2908, memory/storage 2912, user interface 2916, sensors 2920, driver circuitry 2922, power management integrated circuit (PMIC) 2924, antenna structure 2926, and battery 2928. The components of the UE 2900 may be implemented as integrated circuits (ICs), portions thereof, discrete electronic devices, or other modules, logic, hardware, software, firmware, or a combination thereof. The block diagram of FIG. 29 is intended to show a high-level view of some of the components of the UE 2900. However, some of the components shown may be omitted, additional components may be present, and different arrangement of the components shown may occur in other implementations.

The components of the UE 2900 may be coupled with various other components over one or more interconnects 2932, which may represent any type of interface, input/output, bus (local, system, or expansion), transmission line, trace, optical connection, etc. that allows various circuit components (on common or different chips or chipsets) to interact with one another.

The processors 2904 may include processor circuitry such as, for example, baseband processor circuitry (BB) 2904A, central processor unit circuitry (CPU) 2904B, and graphics processor unit circuitry (GPU) 2904C. The processors 2904 may include any type of circuitry or processor circuitry that executes or otherwise operates computer-executable instructions, such as program code, software modules, or functional processes from memory/storage 2912 to cause the UE 2900 to perform operations as described herein.

In some embodiments, the baseband processor circuitry 2904A may access a communication protocol stack 2936 in the memory/storage 2912 to communicate over a 3GPP compatible network. In general, the baseband processor circuitry 2904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 2908.

The baseband processor circuitry 2904A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 2912 may include one or more non-transitory, computer-readable media that includes instructions (for example, communication protocol stack 2936) that may be executed by one or more of the processors 2904 to cause the UE 2900 to perform various operations described herein. The memory/storage 2912 include any type of volatile or non-volatile memory that may be distributed throughout the UE 2900. In some embodiments, some of the memory/storage 2912 may be located on the processors 2904 themselves (for example, L1 and L2 cache), while other memory/storage 2912 is external to the processors 2904 but accessible thereto via a memory interface. The memory/storage 2912 may include any suitable volatile or non-volatile memory such as, but not limited to, dynamic random access memory (DRAM), static random access memory (SRAM), eraseable programmable read only memory (EPROM), electrically eraseable programmable read only memory (EEPROM), Flash memory, solid-state memory, or any other type of memory device technology.

The RF interface circuitry 2908 may include transceiver circuitry and radio frequency front module (RFEM) that allows the UE 2900 to communicate with other devices over a radio access network. The RF interface circuitry 2908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 2926 and proceed to filter and amplify (with a low-noise amplifier) the signal. The signal may be provided to a receiver of the transceiver that down-converts the RF signal into a baseband signal that is provided to the baseband processor of the processors 2904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 2926.

In various embodiments, the RF interface circuitry 2908 may be configured to transmit/receive signals in a manner compatible with NR access technologies.

The antenna structure 2926 may include antenna elements to convert electrical signals into radio waves to travel through the air and to convert received radio waves into electrical signals. The antenna elements may be arranged into one or more antenna panels. The antenna structure 2926 may have antenna panels that are omnidirectional, directional, or a combination thereof to enable beamforming and multiple input, multiple output communications. The antenna structure 2926 may include microstrip antennas, printed antennas fabricated on the surface of one or more printed circuit boards, patch antennas, phased array antennas, etc. The antenna structure 2926 may have one or more panels designed for specific frequency bands including bands in FR1 or FR2.

The user interface 2916 includes various input/output (I/O) devices designed to enable user interaction with the UE 2900. The user interface 2916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 2900.

The sensors 2920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 2922 may include software and hardware elements that operate to control particular devices that are embedded in the UE 2900, attached to the UE 2900, or otherwise communicatively coupled with the UE 2900. The driver circuitry 2922 may include individual drivers allowing other components to interact with or control various input/output (I/O) devices that may be present within, or connected to, the UE 2900. For example, driver circuitry 2922 may include a display driver to control and allow access to a display device, a touchscreen driver to control and allow access to a touchscreen interface, sensor drivers to obtain sensor readings of sensor circuitry 2920 and control and allow access to sensor circuitry 2920, drivers to obtain actuator positions of electro-mechanic components or control and allow access to the electro-mechanic components, a camera driver to control and allow access to an embedded image capture device, audio drivers to control and allow access to one or more audio devices.

The PMIC 2924 may manage power provided to various components of the UE 2900. In particular, with respect to the processors 2904, the PMIC 2924 may control power-source selection, voltage scaling, battery charging, or DC-to-DC conversion.

In some embodiments, the PMIC 2924 may control, or otherwise be part of, various power saving mechanisms of the UE 2900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2900 may power down for brief intervals of time and thus save power. If there is no data traffic activity for an extended period of time, then the UE 2900 may transition off to an RRC_Idle state, where it disconnects from the network and does not perform operations such as channel quality feedback, handover, etc. The UE 2900 goes into a very low power state and it performs paging where again it periodically wakes up to listen to the network and then powers down again. The UE 2900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 2928 may power the UE 2900, although in some examples the UE 2900 may be mounted deployed in a fixed location, and may have a power supply coupled to an electrical grid. The battery 2928 may be a lithium ion battery, a metal-air battery, such as a zinc-air battery, an aluminum-air battery, a lithium-air battery, and the like. In some implementations, such as in vehicle-based applications, the battery 2928 may be a typical lead-acid automotive battery.

FIG. 30 illustrates an example gNB 3000 in accordance with some embodiments. The gNB 3000 may include processors 3004, RF interface circuitry 3008, core network (CN) interface circuitry 3012, memory/storage circuitry 3016, and antenna structure 3026.

The components of the gNB 3000 may be coupled with various other components over one or more interconnects 3028.

The processors 3004, RF interface circuitry 3008, memory/storage circuitry 3016 (including communication protocol stack 3010), antenna structure 3026, and interconnects 3028 may be similar to like-named elements shown and described with respect to FIG. 29.

The CN interface circuitry 3012 may provide connectivity to a core network, for example, a 5th Generation Core network (5GC) using a 5GC-compatible network interface protocol such as carrier Ethernet protocols, or some other suitable protocol. Network connectivity may be provided to/from the gNB 3000 via a fiber optic or wireless backhaul. The CN interface circuitry 3012 may include one or more dedicated processors or FPGAs to communicate using one or more of the aforementioned protocols. In some implementations, the CN interface circuitry 3012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 may include a method of operating a device, comprising identifying information, identifying a network function (NF) of a network to which the information is to be provided, and generating a non-access stratum (NAS) message to indicate an NAS-X connection to be used for transmission of the information to the NF.

Example 2 may include the method of example 1, wherein the NAS message includes a radio resource control (RRC) message, and wherein the RRC message includes an indication of the NAS-X connection.

Example 3 may include the method of example 2, wherein the indication of the NAS-X connection includes an NF identifier (ID) corresponding to the NF.

Example 4 may include the method of example 3, further comprising identifying the NF ID received from a base station or in an NAS-X context.

Example 5 may include the method of example 1, wherein generating the NAS message includes indicating a signaling radio bearer (SRB) for the transmission to the NF, the SRB corresponding to the NAS-X connection.

Example 6 may include the method of example 1, wherein generating the NAS message includes indicating a radio link control (RLC) bearer or a logical channel (LCH) for transmission to the NF, the RLC bearer or LCH corresponding to the NAS-X connection.

Example 7 may include the method of example 1, wherein generating the NAS message includes indicating a signaling radio bearer (SRB) for the transmission to the NF, the SRB corresponding to an NAS-X connection type, wherein the NAS message includes a radio resource control (RRC) message, wherein the RRC message includes an indication of the NAS-X connection of the NAS-X connection type.

Example 8 may include the method of example 1, wherein generating the NAS message includes indicating a logical channel (LCH) for the transmission to the NF, the LCH corresponding to an NAS-X connection type, wherein the NAS message includes a radio resource control (RRC) message, wherein the RRC message includes an indication of the NAS-X connection of the NAS-X connection type.

Example 9 may include the method of example 1, wherein generating the NAS message includes indicating a signaling radio bearer (SRB) for the transmission to the NF, the SRB corresponding to an NAS-X connection type, and indicating a logical channel (LCH) for the transmission to the NF, the LCH corresponding to the NAS-X connection of the NAS-X connection type.

Example 10 may include the method of example 1, wherein generating the NAS message includes indicating a radio resource control (RRC) connection instance for the transmission to the NF, the RRC connection instance corresponding to the NAS-X connection.

Example 11 may include the method of example 1, wherein generating the NAS message includes indicating an NAS connection type corresponding to the NAS-X connection and a service or slice corresponding to the NAS-X connection.

Example 12 may include the method of example 1, wherein the method further comprises identifying entity selection information received from the network, wherein the NF is identified based at least in part on the entity selection information.

Example 13 may include the method of example 12, wherein the entity selection information is received via user equipment route selection policy (URSP) or an access and mobility management function (AMF) connection message.

Example 14 may include the method of example 1, wherein identifying the NF includes identifying an indication from the network that indicates the NAS message is to be provided to the NF, wherein the NF is identified based at least in part on the indication.

Example 15 may include the method of any of examples 1-14, further comprising one or more of the features of any of the examples 16-21.

Example 16 may include a method of operating a device, comprising establishing an NAS-AMF connection with an access and mobility management function (AMF) of a network, identifying an NAS context received from the AMF via the NAS-AMF connection, and establishing an NAS-X connection with a network function (NF) of the network utilizing the NAS context.

Example 17 may include the method of example 16, wherein the NAS context includes a configuration for the NAS-X connection.

Example 18 may include the method of example 16, wherein the NAS context includes an NF identifier (ID) corresponding to the NF.

Example 19 may include the method of example 16, wherein the NAS-X connection is established while the device is in a radio resource control (RRC)-connected state or an RRC-inactive state.

Example 20 may include the method of example 16, wherein the NAS-X connection is established while the device is in an idle state.

Example 21 may include the method of example 16, wherein the NAS-AMF connection is a first NAS-AMF connection, wherein the method further comprises establishing a second NAS-AMF connection subsequent to the first NAS-AMF connection, and wherein the NAS-X connection is established via the second NAS-AMF connection.

Example 22 may include the method of any of examples 16-21, further comprising one or more of the features of any of the examples 1-14.

Example 23 may include a method of operating a base station, comprising identifying a non-access stratum (NAS) message received from a user equipment (UE), determining an NAS-X connection for providing the NAS message to a network function (NF) of a network based at least in part on reception of the NAS message, and providing the NAS message to the NF via the NAS-X connection.

Example 24 may include the method of example 23, wherein the NAS-X connection is determined based at least in part on an indication of the NAS-X connection included in the NAS message.

Example 25 may include the method of example 24, wherein the indication of the NAS-X connection includes an NF identifier (ID) corresponding to the NF.

Example 26 may include the method of example 23, wherein the NAS-X connection is determined based at least in part on a signaling radio bearer (SRB) associated with the reception of the NAS message.

Example 27 may include the method of example 23, wherein the NAS-X connection is determined based at least in part on a radio link control (RLC) bearer or a logical channel (LCH) associated with the reception of the NAS message.

Example 28 may include the method of example 23, wherein the NAS-X connection is determined based at least in part on a signaling radio bearer (SRB) associated with the reception of the NAS message that indicates an NAS-X connection type and an indication of the NAS-X connection of the NAS-X connection type from the NAS message.

Example 29 may include the method of example 23, wherein the NAS-X connection is determined based at least in part on a logical channel (LCH) associated with the reception of the NAS message that indicates an NAS-X connection type and an indication of the NAS-X connection of the NAS-X connection of the NAS-X connection type from the NAS message.

Example 30 may include the method of example 23, wherein the NAS-X connection is determined based at least in part on a signaling radio bearer (SRB) associated with the reception of the NAS message that indicates an NAS-X connection type and a logical channel (LCH) associated with the reception of the NAS message that indicates the NAS-X connection of the NAS-X connection type.

Example 31 may include the method of example 23, wherein the NAS-X connection is determined based at least in part on a radio resource control (RRC) connection instance associated with the reception of the NAS message.

Example 32 may include the method of example 23, wherein the NAS-X connection is determined based at least in part on an NAS connection type and a service or a slice indicated by the UE for the NAS message.

Example 33 may include the method of example 23, wherein the NAS-X connection is determined based at least in part on an indication received from the network.

Example 34 may include an apparatus comprising means to perform one or more elements of a method described in or related to any of examples 1-33, or any other method or process described herein.

Example 35 may include one or more non-transitory computer-readable media comprising instructions to cause an electronic device, upon execution of the instructions by one or more processors of the electronic device, to perform one or more elements of a method described in or related to any of examples 1-33, or any other method or process described herein.

Example 36 may include an apparatus comprising logic, modules, or circuitry to perform one or more elements of a method described in or related to any of examples 1-33, or any other method or process described herein.

Example 37 may include a method, technique, or process as described in or related to any of examples 1-33, or portions or parts thereof.

Example 38 may include an apparatus comprising: one or more processors and one or more computer-readable media comprising instructions that, when executed by the one or more processors, cause the one or more processors to perform the method, techniques, or process as described in or related to any of examples 1-33, or portions thereof.

Example 39 may include a signal as described in or related to any of examples 1-33, or portions or parts thereof.

Example 40 may include a datagram, information element, packet, frame, segment, PDU, or message as described in or related to any of examples 1-33, or portions or parts thereof, or otherwise described in the present disclosure.

Example 41 may include a signal encoded with data as described in or related to any of examples 1-33, or portions or parts thereof, or otherwise described in the present disclosure.

Example 42 may include a signal encoded with a datagram, IE, packet, frame, segment, PDU, or message as described in or related to any of examples 1-33, or portions or parts thereof, or otherwise described in the present disclosure.

Example 43 may include an electromagnetic signal carrying computer-readable instructions, wherein execution of the computer-readable instructions by one or more processors is to cause the one or more processors to perform the method, techniques, or process as described in or related to any of examples 1-33, or portions thereof.

Example 44 may include a computer program comprising instructions, wherein execution of the program by a processing element is to cause the processing element to carry out the method, techniques, or process as described in or related to any of examples 1-33, or portions thereof.

Example 45 may include a signal in a wireless network as shown and described herein.

Example 46 may include a method of communicating in a wireless network as shown and described herein.

Example 47 may include a system for providing wireless communication as shown and described herein.

Example 48 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify information;
identify a network function (NF) of a network to which the information is to be provided; and
generate a non-access stratum (NAS) message to indicate an NAS-X connection to be used for transmission of the information to the NF.

2. The one or more non-transitory, computer-readable media of claim 1, wherein the NAS message includes a radio resource control (RRC) message, and wherein the RRC message includes an indication of the NAS-X connection.

3. The one or more non-transitory, computer-readable media of claim 2, wherein the indication of the NAS-X connection includes an NF identifier (ID) corresponding to the NF.

4. The one or more non-transitory, computer-readable media of claim 1, wherein to generate the NAS message includes to indicate a signaling radio bearer (SRB) for the transmission to the NF, the SRB corresponding to the NAS-X connection.

5. The one or more non-transitory, computer-readable media of claim 1, wherein to generate the NAS message includes to indicate a radio link control (RLC) bearer or a logical channel (LCH) for transmission to the NF, the RLC bearer or LCH corresponding to the NAS-X connection.

6. The one or more, non-transitory computer-readable media of claim 1, wherein to generate the NAS message includes to indicate a signaling radio bearer (SRB) for the transmission to the NF, the SRB corresponding to an NAS-X connection type, wherein the NAS message includes a radio resource control (RRC) message, wherein the RRC message includes an indication of the NAS-X connection of the NAS-X connection type.

7. The one or more non-transitory, computer-readable media of claim 1, wherein to generate the NAS message includes to indicate a logical channel (LCH) for the transmission to the NF, the LCH corresponding to an NAS-X connection type, wherein the NAS message includes a radio resource control (RRC) message, wherein the RRC message includes an indication of the NAS-X connection of the NAS-X connection type.

8. The one or more non-transitory, computer-readable media of claim 1, wherein to generate the NAS message includes to indicate a signaling radio bearer (SRB) for the transmission to the NF, the SRB corresponding to an NAS-X connection type, and indicating a logical channel (LCH) for the transmission to the NF, the LCH corresponding to the NAS-X connection of the NAS-X connection type.

9. The one or more non-transitory, computer-readable media of claim 1, wherein to generate the NAS message includes to indicate a radio resource control (RRC) connection instance for the transmission to the NF, the RRC connection instance corresponding to the NAS-X connection.

10. An apparatus comprising:
processing circuitry to:
establish an NAS-AMF connection with an access and mobility management function (AMF) of a network;
identify an NAS context received from the AMF via the NAS-AMF connection; and
establish an NAS-X connection with a network function (NF) of the network utilizing the NAS context; and
interface circuitry coupled with the processing circuitry, the interface circuitry to enable communication.

11. The apparatus of claim 10, wherein the NAS context includes a configuration for the NAS-X connection.

12. The apparatus of claim 10, wherein the NAS context includes an NF identifier (ID) corresponding to the NF.

13. The apparatus of claim 10, wherein the NAS-X connection is established while the apparatus is in a radio resource control (RRC)-connected state or an RRC-inactive state.

14. The apparatus of claim 10, wherein the NAS-X connection is established while the apparatus is in an idle state.

15. The apparatus of claim 10, wherein the NAS-AMF connection is a first NAS-AMF connection, wherein the processing circuitry is further to establish a second NAS-AMF connection subsequent to the first NAS-AMF connection, and wherein the NAS-X connection is established via the second NAS-AMF connection.

16. A method comprising:
identifying a non-access stratum (NAS) message received from a user equipment (UE);
determining an NAS-X connection for providing the NAS message to a network function (NF) of a network based at least in part on reception of the NAS message; and
providing the NAS message to the NF via the NAS-X connection.

17. The method of claim 16, wherein the NAS-X connection is determined based at least in part on an indication of the NAS-X connection included in the NAS message.

18. The method of claim 16, wherein the NAS-X connection is determined based at least in part on a signaling radio bearer (SRB) associated with the reception of the NAS message.

19. The method of claim 16, wherein the NAS-X connection is determined based at least in part on a radio link control (RLC) bearer or a logical channel (LCH) associated with the reception of the NAS message.

20. The method of claim 16, wherein the NAS-X connection is determined based at least in part on a signaling radio bearer (SRB) associated with the reception of the NAS message that indicates an NAS-X connection type and an indication of the NAS-X connection of the NAS-X connection type from the NAS message.
